(19) United States
(12) Patent Application Publication
(10) Pub. No.: US 2017/0022419 A1
(43) Pub. Date: Jan. 26, 2017

(54) LIQUID CRYSTAL ALIGNMENT AGENT, LIQUID CRYSTAL ALIGNMENT FILM, AND LIQUID CRYSTAL DISPLAY ELEMENT

(71) Applicant: Chi Mei Corporation, Tainan City (TW)

(72) Inventor: Shin-Rong Chiou, Kaohsiung City (TW)

(21) Appl. No.: 15/207,508

(22) Filed: Jul. 12, 2016

(30) Foreign Application Priority Data
Jul. 20, 2015 (TW) 104123417

(51) Int. Cl. C09K 19/56; G02F 1/1337; C08G 77/18; C08G 77/06; C08G 73/12; C08G 73/10

(52) U.S. Cl. CPC C09K 19/56; C08G 73/12; C08G 73/1042; C08G 73/1007; C08G 77/18; C08G 77/06; G02F 1/133723; G02F 1/133719

(57) ABSTRACT

A liquid crystal alignment agent capable of forming a liquid crystal alignment film having good pre-tilt angle light stability, the liquid crystal alignment film, and a liquid crystal display element having the liquid crystal alignment film are provided. The liquid crystal alignment agent includes a polymer (A), a photosensitive polysiloxane (B), and a solvent (C). The polymer (A) is obtained by reacting a mixture, wherein the mixture includes a tetracarboxylic dianhydride component (a1) and a diamine component (a2). The diamine component (a2) includes a diamine compound (a2-1) represented by formula (1). The photosensitive polysiloxane (B) is obtained by reacting a silane compound (b1-1) containing an epoxy group and a cinnamic acid derivative (b2).

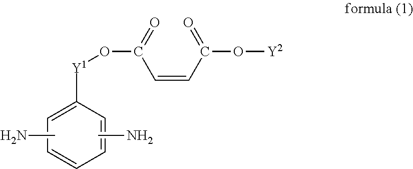

### CROSS-REFERENCE TO RELATED APPLICATION

This application claims the priority benefit of Taiwan application serial no. 104123417, filed on Jul. 20, 2015. The entirety of the above-mentioned patent application is hereby incorporated by reference herein and made a part of this specification.

### BACKGROUND OF THE INVENTION

Field of the Invention

The invention relates to a perpendicular alignment liquid crystal alignment agent, a liquid crystal alignment film, and a liquid crystal display element. More particularly, the invention relates to a liquid crystal alignment agent capable of forming a liquid crystal alignment film having good pre-tilt angle light stability, a liquid crystal alignment film formed by the liquid crystal alignment agent, and a liquid crystal display element having the liquid crystal alignment film.

Description of Related Art

The liquid crystal display (LCD) is widely applied in, for instance, television and various monitors. An LCD display element having the following types of liquid crystal cell is known: twisted nematic (TN)-type, super-twisted nematic (STN)-type, in-plane switching (IPS)-type, and fringe field switching (FFS)-type changing the electrode structures of IPS-type which increases brightness by increasing the aperture ratio of the display element component . . . etc.

The following is a known method for aligning the liquid crystal of liquid crystal cells: an organic film such as a liquid crystal alignment film is formed on the surface of a substrate, and a cloth material such as rayon is used to rub the surface of the organic film in a certain direction; silicon oxide is deposited on the surface of the substrate diagonally via vapor deposition; and a Langmuir-Blodgett (LB) method is used to form a monomolecular film having a long-chain alkyl group. In particular, from the viewpoint of substrate size, uniformity of liquid crystal alignment, treatment time, and treatment cost, a rubbing treatment is most commonly used.

However, if a rubbing treatment is used to perform liquid crystal alignment, then dust may be adhered to the surface of the alignment film due to dust or static electricity generated during the process, thus causing poor display. In particular, for a substrate having a thin film transistor (TFT) element, the generated static electricity causes damage to the circuit of the TFT element, thus causing reduced yield. Moreover, for the liquid crystal display element becoming more and more highly delicate in the future, with the high densification of the pixels, the surface of the substrate becomes uneven, and therefore it is difficult to perform a uniform rubbing treatment.

As a result, to avoid such undesired situation, a photoalignment method (such as Japanese Patent Laid-Open Publication No. 2005-037654) providing liquid crystal alignment capability by irradiating polarized or non-polarized radiation on a photosensitive thin film is known. The patent literature provides a repeating unit having conjugated enone and a liquid crystal alignment agent having an imide structure. Accordingly, static electricity and dust are not generated, and therefore uniform liquid crystal alignment can be achieved. Moreover, in comparison to the rubbing treatment, the method can precisely control the direction of liquid crystal alignment in any direction. Furthermore, by using, for instance, a photomask when radiation is irradiated, a plurality of regions having different directions of liquid crystal alignment can be formed on one substrate in any manner.

However, the liquid crystal alignment film has the drawback of insufficient pre-tilt angle light stability, and therefore the issue of low quality readily occurs to the subsequently-formed liquid crystal display element, such that the liquid crystal display element is not acceptable to the industries. Therefore, how to provide a liquid crystal alignment agent capable of forming a liquid crystal alignment film having good pre-tilt angle light stability, such that a better display quality can be achieved when the liquid crystal alignment film formed thereby is applied in a liquid crystal display element, is a current issue that those skilled in the art urgently need to solve.

### SUMMARY OF THE INVENTION

Accordingly, the invention provides a liquid crystal alignment agent capable of forming a liquid crystal alignment film having good pre-tilt angle light stability, a liquid crystal alignment film formed by the liquid crystal alignment agent, and a liquid crystal display element having the liquid crystal alignment film.

The invention provides a liquid crystal alignment agent including a polymer (A), a photosensitive polysiloxane (B), and a solvent (C). The polymer (A) is obtained by reacting a mixture, wherein the mixture includes a tetracarboxylic dianhydride component (a1) and a diamine component (a2). The diamine component (a2) includes a diamine compound (a2-1) represented by formula (1). The photosensitive polysiloxane (B) is obtained by reacting a silane compound (b1-1) containing an epoxy group and a cinnamic acid derivative (b2).

Specifically, the diamine compound (a2-1) represented by formula (1) is as shown below.

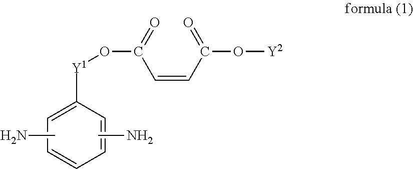

In formula (1), Y1 represents a C₁ to C₁₂ alkylene group; Y2 represents a group having a steroid skeleton or a group represented by formula (1-1), wherein the group represented by formula (1-1) is as shown below.

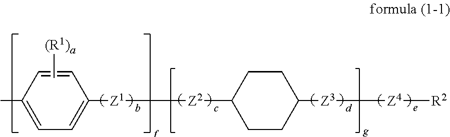

In formula (1-1), R¹ each independently represents a fluorine atom or a methyl group; R² represents a hydrogen atom, a fluorine atom, a C₁ to C₁₂ alkyl group, a C₁ to C₁₂ fluoroalkyl group, a C₁ to C₁₂ alkoxy group, —OCH₂F, —OCHF₂, or —OCF₃; Z¹, Z², and Z³ each independently represent a single bond, a C₁ to C₃ alkylene group,

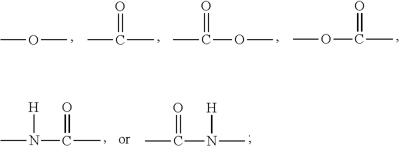

Z⁴ each independently represents

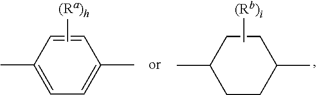

R^{a} and R^{b} each independently represent a fluorine atom or a methyl group, h and i each independently represent 0, 1, or 2; a represents 0, 1, or 2; b, c, and d each independently represent an integer of 0 to 4; and e, f, and g each independently represent an integer of 0 to 3, and e+f+g≧1.

In an embodiment of the invention, the silane compound (b1-1) containing an epoxy group includes at least one of a group represented by formula (2-1), a group represented by formula (2-2), and a group represented by formula (2-3).

Specifically, the group represented by formula (2-1) is as shown below.

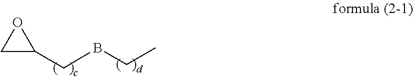

In formula (2-1), B represents an oxygen atom or a single bond; c represents an integer of 1 to 3; d represents an integer of 0 to 6, wherein when d represents 0, B is a single bond.

Moreover, the group represented by formula (2-2) is as shown below.

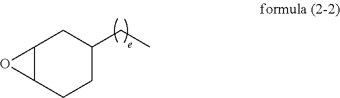

In formula (2-2), e represents an integer of 0 to 6.

The group represented by formula (2-3) is as shown below.

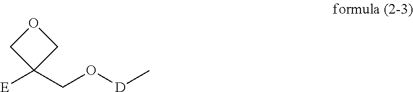

In formula (2-3), D represents a C₂ to C₆ alkylene group; E represents a hydrogen atom or a C₁ to C₆ alkyl group.

In an embodiment of the invention, the cinnamic acid derivative (b2) is at least one in the group consisting of compounds represented by formula (3-1) to formula (3-2).

Specifically, the group represented by formula (3-1) is as shown below.

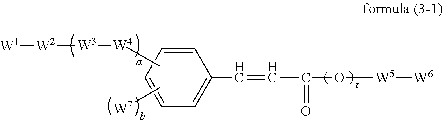

In formula (3-1), W¹ represents a hydrogen atom, a C₁ to C₄₀ alkyl group, or a C₃ to C₄₀ monovalent organic group containing an alicyclic group, wherein a portion of or all of the hydrogen atoms of the alkyl group can be substituted by fluorine atoms; W² represents a single bond, an oxygen atom, —COO—, or —OCO—; W³ represents a divalent aromatic group, a divalent alicyclic group, a divalent heterocyclic group, or a divalent fused-ring group; W⁴ represents a single bond, an oxygen atom, —COO—, or —OCO—; W⁵ represents a single bond, a methylene group, a C₂ to C₁₀ alkylene group, or a divalent aromatic group; when W⁵ represents a single bond, t represents 0, and W⁶ is a hydroxyl group or —SH; when W⁵ represents a methylene group, an alkylene group, or a divalent aromatic group, t represents 0 or 1, and W⁶ is a carboxylic acid group, a hydroxyl group, —SH, —NCO, —NHW, —CH═CH₂, or —SO₂Cl, wherein W represents a hydrogen atom or a C₁ to C₆ alkyl group; W⁷ represents a fluorine atom or a cyano group; a represents an integer of 0 to 3; and b represents an integer of 0 to 4.

The group represented by formula (3-2) is as shown below.

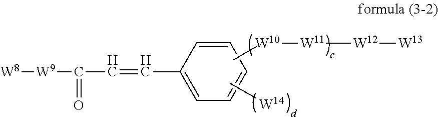

In formula (3-2), W⁸ represents a C₁ to C₄₀ alkyl group or a C₃ to C₄₀ monovalent organic group containing an alicyclic group, wherein a portion of or all of the hydrogen atoms of the alkyl group can be substituted by fluorine atoms; W⁹ represents a single bond, an oxygen atom, or a divalent aromatic group; W¹⁰ represents an oxygen atom, —COO—, or —OCO—; W¹¹ represents a divalent aromatic group, a divalent heterocyclic group, or a divalent fused-ring group; W¹² represents a single bond, —OCO—(CH₂)ₑ—*, or —O—(CH₂)_{g}—*, wherein e and g each independently represent an integer of 1 to 10, and * each independently represents a bond with W¹³; W¹³ represents a carboxylic acid group, a hydroxyl group, —SH, —NCO, —NHW, —CH═CH₂, or —SO₂Cl, wherein W represents a hydrogen atom or a C₁ to C₆ alkyl group; W¹⁴ represents a fluorine atom or a cyano group; c represents an integer of 0 to 3; and d represents an in integer of 0 to 4.

In an embodiment of the invention, based on a usage amount of 100 moles of the diamine component (a2), the usage amount of the diamine compound (a2-1) is 0.5 moles to 20 moles.

In an embodiment of the invention, based on 100 parts by weight of the polymer (A), the usage amount of the photosensitive polysiloxane (B) is 3 parts by weight to 30 parts by weight; and the usage amount of the solvent (C) is 800 parts by weight to 4000 parts by weight.

In an embodiment of the invention, the molar equivalent ratio (b2)/(b1-1) of the cinnamic acid derivative (b2) to the silane compound (b1-1) containing an epoxy group is 0.1 to 0.7.

In an embodiment of the invention, the imidization ratio of the polymer (A) is 3% to 50%.

The invention further provides a liquid crystal alignment film. The liquid crystal alignment film is formed by the above liquid crystal alignment agent.

The invention further provides a liquid crystal display element. The liquid crystal display element includes the above liquid crystal alignment film.

Based on the above, the pre-tilt angle light stability of the liquid crystal alignment film formed by the liquid crystal alignment agent of the invention is good such that the liquid crystal alignment film is suitable for a liquid crystal display element.

In order to make the aforementioned features and advantages of the disclosure more comprehensible, embodiments accompanied with FIGURES are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a liquid crystal display element according to an embodiment of the invention.

### DESCRIPTION OF THE EMBODIMENTS

### Liquid Crystal Alignment Agent

The invention provides a liquid crystal alignment agent including a polymer (A), a photosensitive polysiloxane (B), and a solvent (C). Moreover, the liquid crystal alignment agent can further include an additive (D) if needed.

In the following, each component of the liquid crystal alignment agent of the invention is described in detail.

It should be mentioned that, in the following, (meth)acrylic acid represents acrylic acid and/or methacrylic acid, and (meth)acrylate represents acrylate and/or methacrylate. Similarly, (meth)acryloyl group represents acryloyl group and/or methacryloyl group.

### Polymer (A)

The polymer (A) is obtained by reacting a mixture. The mixture includes a tetracarboxylic dianhydride component (a1) and a diamine component (a2).

Specifically, the polymer (A) includes a polyamic acid, a polyimide, a polyamic acid-polyimide block copolymer, or a combination of the polymers. In particular, the polyimide-based block copolymer includes a polyamic acid block copolymer, a polyimide block copolymer, a polyamic acid-polyimide block copolymer, or a combination of the polymers. The polyamic acid polymer, the polyimide polymer, and the polyamic acid-polyimide block copolymer can all be obtained by reacting a mixture of the tetracarboxylic dianhydride component (a1) and the diamine component (a2).

### Tetracarboxylic Dianhydride Component (a1)

The tetracarboxylic dianhydride component (a1) includes an aliphatic tetracarboxylic dianhydride compound, an alicyclic tetracarboxylic dianhydride compound, an aromatic tetracarboxylic dianhydride compound, at least one of the tetracarboxylic dianhydride compounds represented by formula (I-1) to formula (I-6), or a combination of the compounds.

Specific examples of the aliphatic tetracarboxylic dianhydride compound, the alicyclic tetracarboxylic dianhydride compound, and the aromatic tetracarboxylic dianhydride compound are listed below. However, the invention is not limited to the specific examples.

Specific examples of the aliphatic tetracarboxylic dianhydride compound can include, but are not limited to, ethane tetracarboxylic dianhydride, butane tetracarboxylic dianhydride, or a combination of the compounds.

Specific examples of the alicyclic tetracarboxylic dianhydride compound can include, but are not limited to, 1,2,3,4-cyclobutane tetracarboxylic dianhydride, 1,2-dimethyl-1,2,3,4-cyclobutane tetracarboxylic dianhydride, 1,3-dimethyl-1,2,3,4-cyclobutane tetracarboxylic dianhydride, 1,3-dichloro-1,2,3,4-cyclobutane tetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexyl tetracarboxylic dianhydride, cis-3,7-dibutyl-cycloheptyl-1,5-diene-1,2,5, 6-tetracarboxylic dianhydride, 2,3,5-tricarboxycyclopentylacetic dianhydride, or a combination of the compounds.

Specific examples of the aromatic tetracarboxylic dianhydride compound can include, but are not limited to, an aromatic tetracarboxylic dianhydride compound such as 3,4-dicarboxy-1,2,3,4-tetrahydronaphthalene-1-succinic dianhydride, pyromellitic dianhydride, 3,3′,4,4′-benzophenone tetracarboxylic dianhydride, 3′,3,4,4′-biphenylsulfone tetracarboxylic dianhydride, 1,4,5,8-naphthalene tetracarboxylic dianhydride, 2,3,6,7-naphthalene tetracarboxylic dianhydride, 3,3′4,4′-diphenyl ethane tetracarboxylic dianhydride, 3,3′,4,4′-dimethyl diphenyl silane tetracarboxylic dianhydride, 3,3′,4,4′-tetraphenyl silane tetracarboxylic dianhydride, 1,2,3,4-furan tetracarboxylic dianhydride, 4,4′-bis(3,4-dicarboxy phenoxy)diphenylsulfide dianhydride, 4,4′-bis(3,4-dicarboxy phenoxy)diphenylsulfone dianhydride, 4,4′-bis(3,4-dicarboxy phenoxy)diphenylpropane dianhydride, 3,3′,4,4′-perfluoroisopropylidene diphenyl dicarboxylic dianhydride, 3,3′,4,4′-diphenyl tetracarboxylic dianhydride, bis(phthalic acid)phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenylether dianhydride, bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofuran tetracarboxylic dianhydride, 1,3,3a,4,5,9b-hexahydro-5-(tetrahydro-2,5-dioxo-3-furanyl)naphtho[1,2-c]furan-1,3-dione, 1,3,3a,4,5,9b-hexahydro-5-methyl-5-(tetrahydro-2,5-dioxo-3-furanyl)naphtho[1,2-c]furan-1,3-dione, 1,3,3a,4,5,9b-hexahydro-5-ethyl-5-(tetrahydro-2,5-dioxo-3-furanyl)naphtho[1,2-c]furan-1,3-dione, 1,3,3a,4,5,9b-hexahydro-7-methyl-5-(tetrahydro-2,5-dioxo-3-furanyl) naphtho[1,2-c]furan-1,3-dione, 1,3,3a,4,5,9b-hexahydro-7-ethyl-5-(tetrahydro-2,5-dioxo-3-furanyl)naphtho[1,2-c]furan-1,3-dione, 1,3,3a,4,5,9b-hexahydro-8-methyl-5-(tetrahydro-2,5-dioxo-3-furanyl)naphtho[1,2-c]furan-1,3-dione, 1,3,3a,4,5,9b-hexahydro-8-ethyl-5-(tetrahydro-2,5-dioxo-3-furanyl)naphtho[1,2-c]furan-1,3-dione, 1,3,3a,4,5,9b-hexahydro-5,8-dimethyl-5-(tetrahydro-2,5-dioxo-3-furanyl)naphtho[1,2-c]furan-1,3-dione, 5-(2,5-dioxotetrahydrofural)-3-methyl-3-cyclohexene-1,2-dicarboxylic dianhydride, or a combination of the compounds.

The tetracarboxylic dianhydride compounds represented by formula (I-1) to formula (I-6) are as shown below.

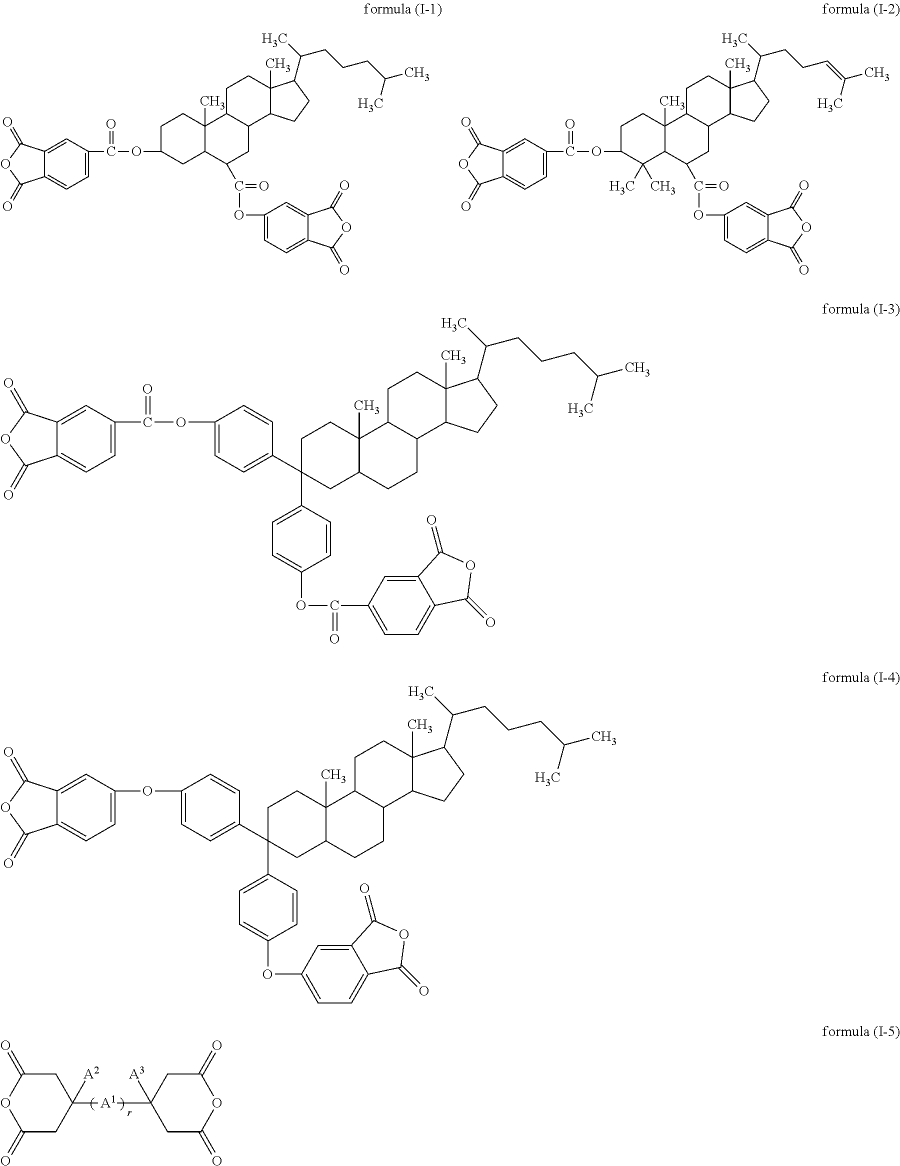

In formula (I-5), A¹ represents a divalent group containing an aromatic ring; r represents an integer of 1 to 2; A² and A³ can be the same or different, and can each independently represent a hydrogen atom or an alkyl group. Specific examples of the tetracarboxylic dianhydride compound represented by formula (I-5) include at least one of the compounds represented by formula (I-5-1) to formula (I-5-3).

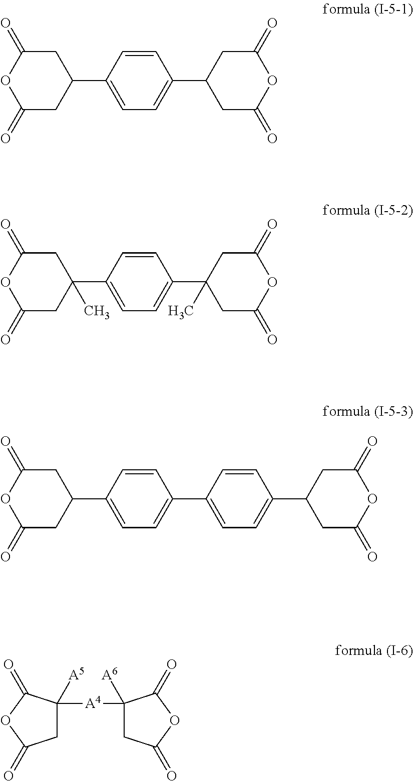

In formula (I-6), A⁴ represents a divalent group containing an aromatic ring; A⁵ and A⁶ can be the same or different, and each independently represent a hydrogen atom or an alkyl group. The tetracarboxylic dianhydride compound represented by formula (I-6) is preferably a compound represented by formula (I-6-1).

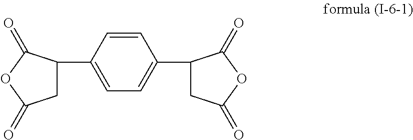 [SMILES: O=C1CC(c2ccc(C3CC(=O)OC3=O)cc2)C(=O)O1]

The tetracarboxylic dianhydride component (a1) can be used alone or in multiple combinations.

Specific examples of the tetracarboxylic dianhydride component (a1) preferably include 1,2,3,4-cyclobutane tetracarboxylic dianhydride, 1,2,3,4-cyclopentane tetracarboxylic dianhydride, 2,3,5-tricarboxycyclopentylacetic dianhydride, 1,2,4,5-cyclohexane tetracarboxylic dianhydride, 3,4-dicarboxy-1,2,3,4-tetrahydronaphthalene-1-succinic dianhydride, pyromellitic dianhydride, 3,3′,4,4′-benzophenone tetracarboxylic dianhydride, 3′,3,4,4′-diphenylsulfone tetracarboxylic dianhydride, a compound represented by formula (I-1), or a combination of the compounds.

Based on a total number of moles of 100 moles of the diamine component (a2), the range of usage amount of the tetracarboxylic dianhydride component (a1) is preferably 20 moles to 200 moles, more preferably 30 moles to 120 moles.

### Diamine Component (a2)

The diamine component (a2) includes a diamine compound (a2-1) and a diamine compound (a2-2).

Diamine Compound (a2-1)

The diamine compound (a2-1) is a compound represented by formula (1).

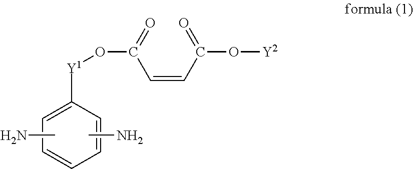

In formula (1), Y¹ represents a C₁ to C₁₂ alkylene group; and Y² represents a group having a steroid (cholesterol) skeleton or a group represented by formula (1-1).

The group represented by formula (1-1) is as shown below.

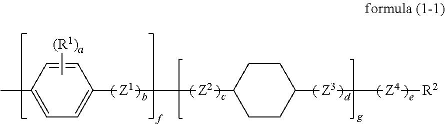

In formula (1-1), R¹ each independently represents a fluorine atom or a methyl group; R² represents a hydrogen atom, a fluorine atom, a C₁ to C₁₂ alkyl group, a C₁ to C₁₂ fluoroalkyl group, a C₁ to C₁₂ alkoxy group, —OCH₂F, —OCHF₂, or —OCF₃; Z¹, Z², and Z³ each independently represent a single bond, a C₁ to C₃ alkylene group,

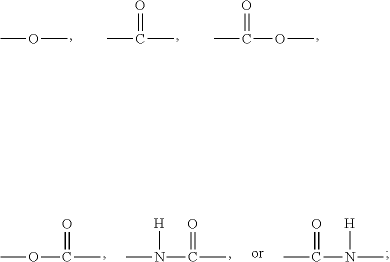

Z⁴ each independently represents

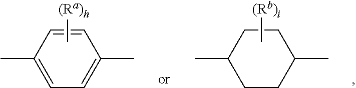

R^{a} and R^{b} each independently represent a fluorine atom or a methyl group, h and i each independently represent 0, 1, or 2; a represents 0, 1, or 2; b, c, and d each independently represent an integer of 0 to 4; and e, f, and g each independently represent an integer of 0 to 3, and e+f+g≧1.

Specific examples of the diamine compound (a2-1) include at least one of the compounds represented by formula (1-2) to formula (1-19).

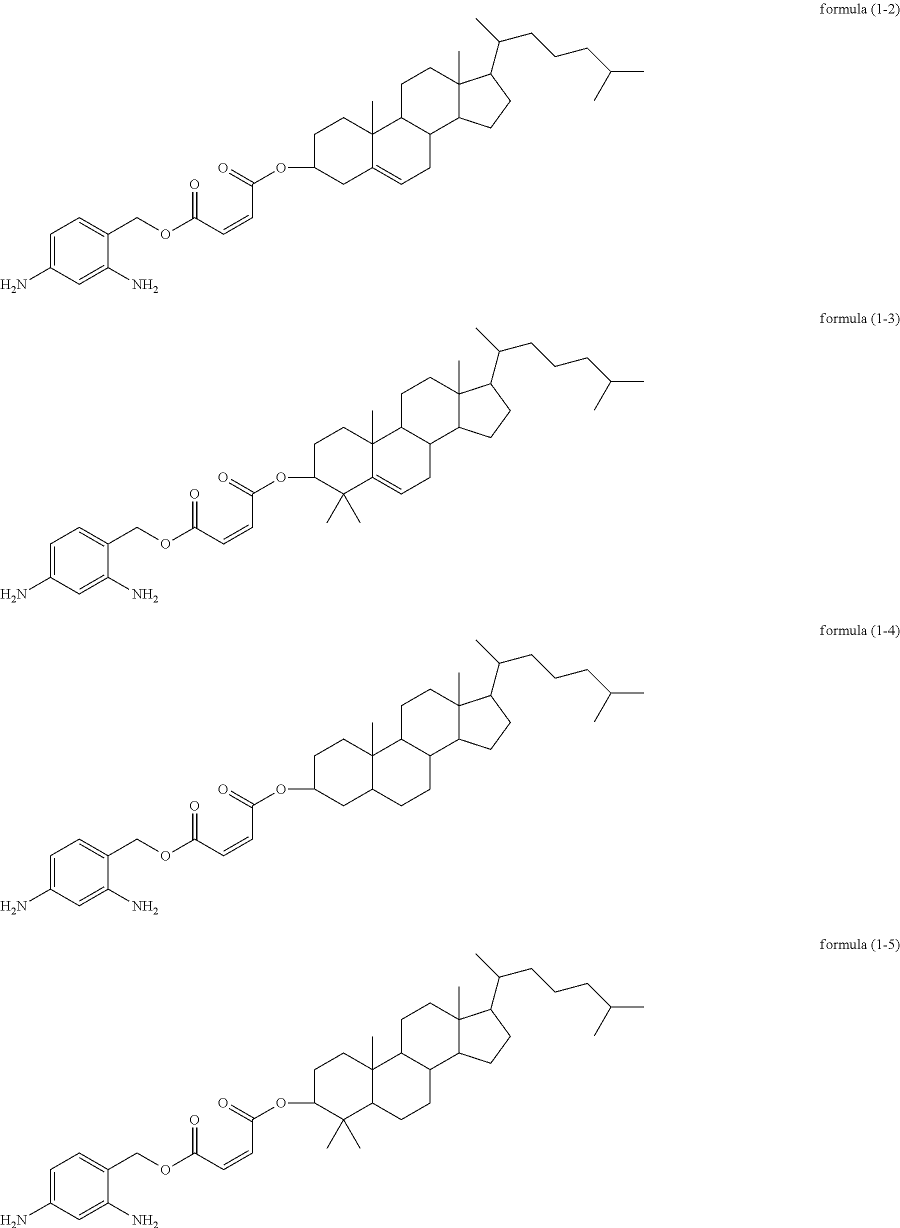 [SMILES: CC(C)CCCC(C)C1CCC2C3CC=C4CC(OC(=O)/C=C\C(=O)OCc5ccc(N)cc5N)CCC4(C)C3CCC12C ; CC(C)CCCC(C)C1CCC2C3CC=C4C(C)(C)C(OC(=O)/C=C\C(=O)OCc5ccc(N)cc5N)CCC4(C)C3CCC12C ; CC(C)CCCC(C)C1CCC2C3CCC4CC(OC(=O)/C=C\C(=O)OCc5ccc(N)cc5N)CCC4(C)C3CCC12C ; CC(C)CCCC(C)C1CCC2C3CCC4C(C)(C)C(OC(=O)/C=C\C(=O)OCc5ccc(N)cc5N)CCC4(C)C3CCC12C]

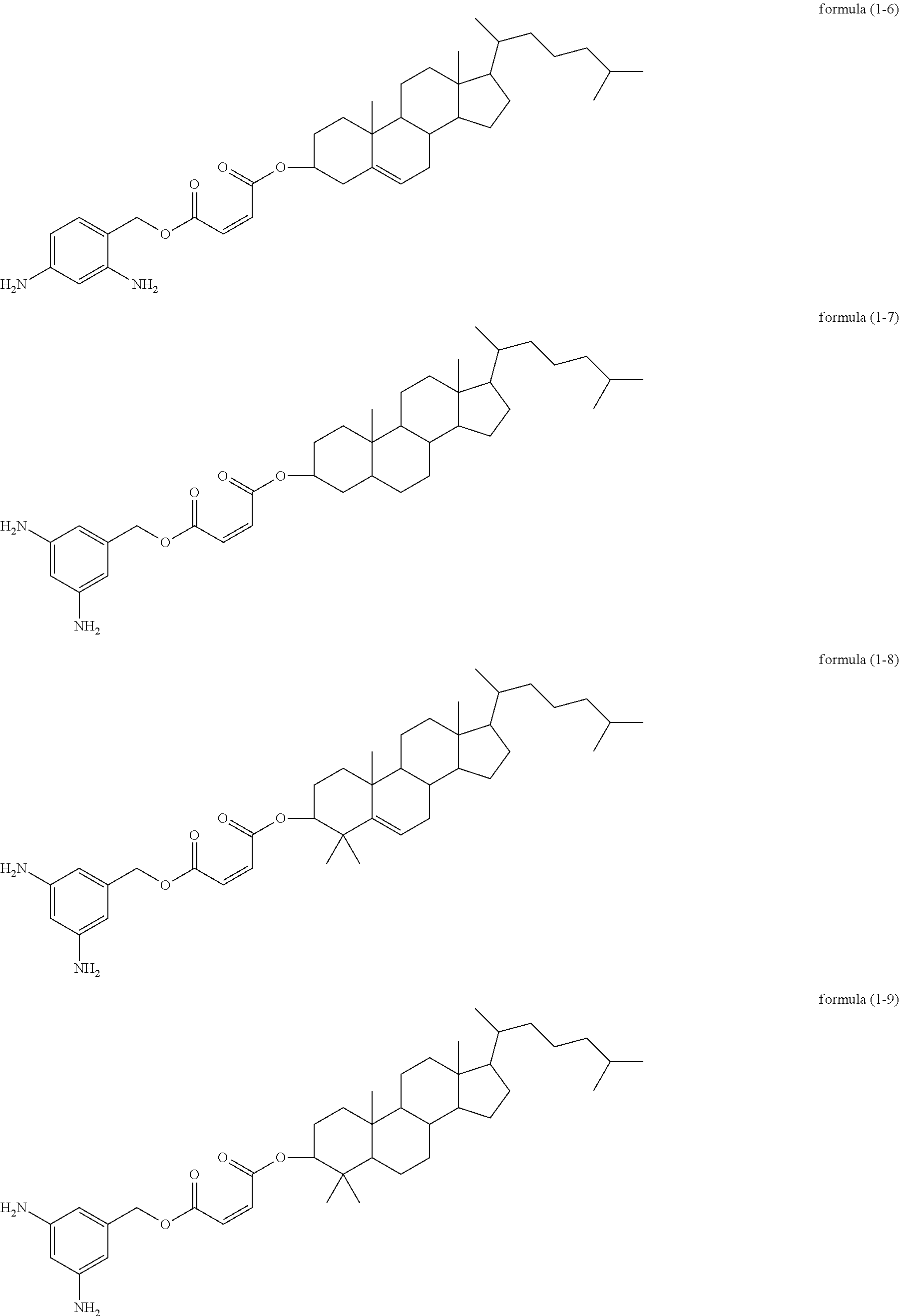 [SMILES: CC(C)CCCC(C)C1CCC2C3CC=C4CC(OC(=O)/C=C\C(=O)OCc5ccc(N)cc5N)CCC4(C)C3CCC12C ; CC(C)CCCC(C)C1CCC2C3CCC4CC(OC(=O)/C=C\C(=O)OCc5cc(N)cc(N)c5)CCC4(C)C3CCC12C ; CC(C)CCCC(C)C1CCC2C3CC=C4C(C)(C)C(OC(=O)/C=C\C(=O)OCc5cc(N)cc(N)c5)CCC4(C)C3CCC12C ; CC(C)CCCC(C)C1CCC2C3CCC4C(C)(C)C(OC(=O)/C=C\C(=O)OCc5cc(N)cc(N)c5)CCC4(C)C3CCC12C]

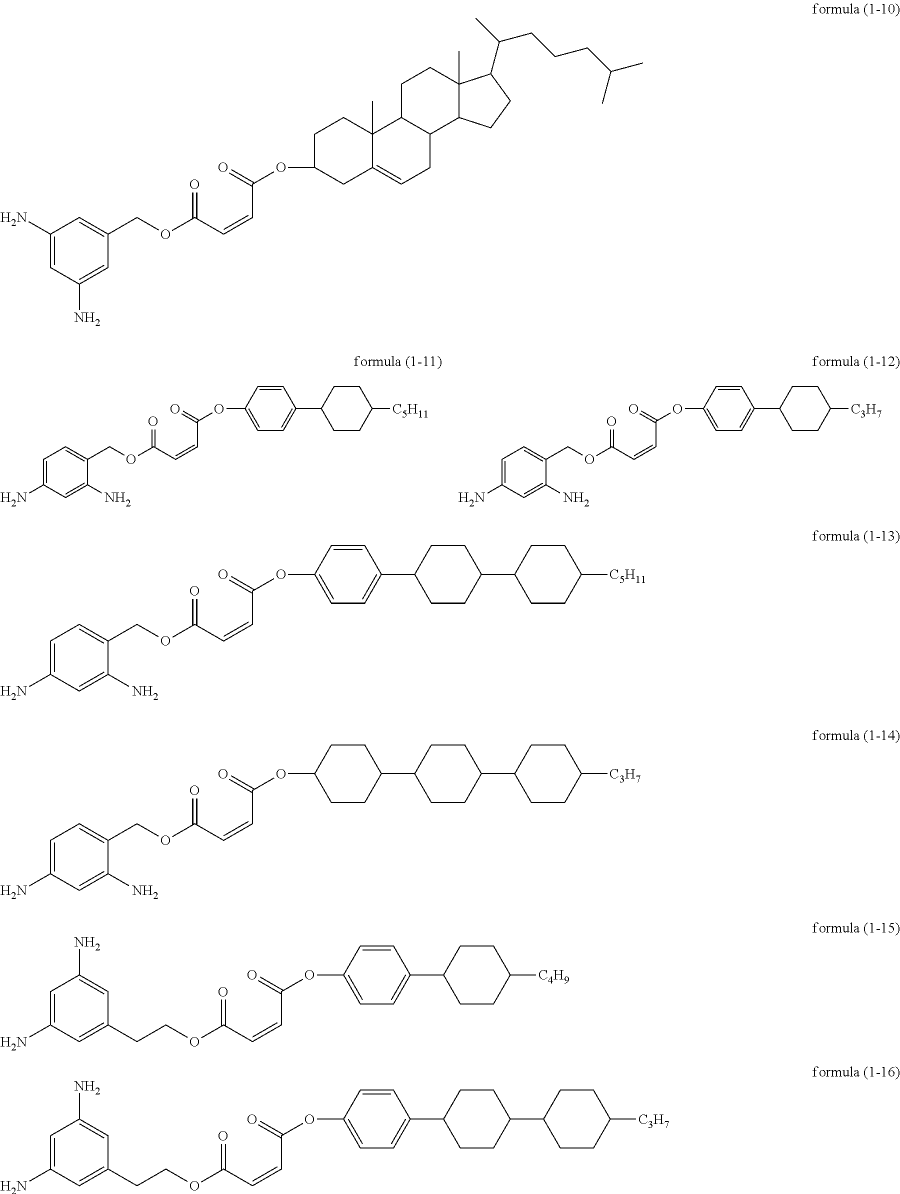

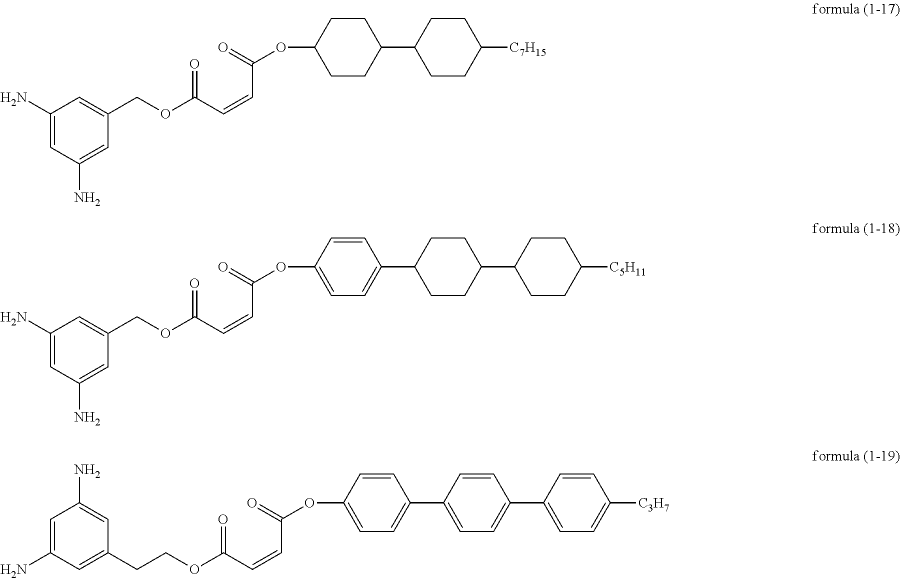

The diamine compound (a2-1) can be prepared by a general organic synthesis method. For instance, the compounds represented by formula (1-2) to formula (1-19) can respectively be formed by first adding a maleic anhydride on a compound having a steroid skeleton or a compound represented by formula (1-20). Next, in the presence of potassium carbonate, a dinitrobenzoyl chloride compound is added to perform an esterification reaction. Then, a reduction reaction is performed by adding a suitable reducing agent such as tin chloride to synthesize the diamine compound (a2-1).

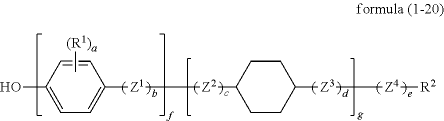

In formula (1-20), the definition of each of R¹, R², Z¹, Z², Z³, Z⁴, a, b, c, d, e, f, and g is respectively the same as the definition of each of R¹, R², Z¹, Z², Z³, Z⁴, a, b, c, d, e, f, and g in formula (1-1), and is not repeated herein.

The compound represented by formula (1-20) can be synthesized by a general method such as a Grignard reaction or a Friedal-Crafts acylation reaction for synthesizing a liquid crystal compound.

The diamine compound (a2-1) represented by formula (1) is preferably at least one in the group consisting of the diamine compounds represented by formula (1-2), formula (1-7), formula (1-10), formula (1-12), formula (1-15), formula (1-16), formula (1-17), and formula (1-18).

Based on a usage amount of 100 moles of the diamine component (a2), the usage amount of the diamine compound (a2-1) is 0.5 moles to 20 moles, preferably 0.8 moles to 15 moles, more preferably 1 mole to 10 moles. When the liquid crystal alignment agent does not contain the diamine compound (a2-1), the liquid crystal alignment film has the issue of poor pre-tilt angle light stability.

Diamine Compound (a2-2)

The diamine compound (a2-2) includes an aliphatic diamine compound, an alicyclic diamine compound, an aromatic diamine compound, a diamine compound having structural formula (II-1) to formula (II-30), or a combination thereof.

Specific examples of the aliphatic diamine compound include, but are not limited to, 1,2-diamino ethane, 1,3-diaminopropane, 1,4-diaminobutane, 1,5-diaminopentane, 1,6-diaminohexane, 1,7-diaminoheptane, 1,8-diaminooctane, 1,9-di aminononane, 1,10-diaminodecane, 4,4′-di aminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, or a combination of the compounds.

Specific examples of the alicyclic diamine compound include, but are not limited to, 4,4′-diaminodicyclohexylmethane, 4,4′-diamino-3,3′-dimethyldicyclohexylamine, 1,3-diamino cyclohexane, 1,4-diaminocyclohexane, isophorone diamine, tetrahydrodicyclopentadiene diamine, tricyclo[6.2.1.0^{2,7}]-undecenedimethyldiamine, 4,4′-methylene bis(cyclohexylamine), or a combination of the compounds.

Specific examples of the aromatic diamine compound include, but are not limited to, 4,4′-diaminodiphenylmethane, 4,4′-diaminodiphenylethane, 4,4′-diaminodiphenylsulfone, 4,4′-diaminobenzoylaniline, 4,4′-diaminostilbene, 4,4′-diamino diphenyl ether, 3,4′-diaminodiphenylether, 3,3′-diaminochalcone, 1,5-diaminonaphthalene, 5-amino-1-(4′-aminophenyl)-1,3,3-trimethylindene, 6-amino-1-(4 ‘-aminophenyl)-1,3,3-trimethylindene, hexahydro-4,7-methanoindanylene dimethylenediamine, 3,3’-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9.9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, 4,4′-bis[(4-amino-2-trifluoromethyl)phenoxy]-octafluorobiphenyl, 5-[4-(4-n-pentylcyclohexyl) cyclohexyl]phenylmethylene-1,3-diaminobenzene, 1, 1-bis[4-(4-aminophenoxy)phenyl]-4-(4-ethylphenyl)cyclohexane, or a combination of the compounds.

The diamine compound having structural formula (II-1) to formula (II-30) is as shown below.

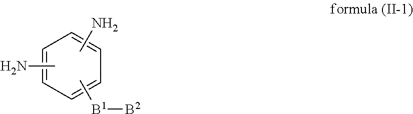

In formula (II-1), B¹ represents

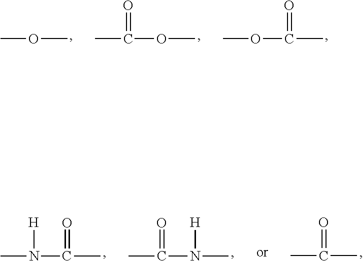

and B² represents a group having a steroid (cholesterol) skeleton, a trifluoromethyl group, a fluorine atom, a C₂ to C₃₀ alkyl group, or a monovalent group of a cyclic structure containing a nitrogen atom derived from, for instance, pyridine, pyrimidine, triazine, piperidine, or piperazine.

Specific examples of the compound represented by formula (II-1) include, but are not limited to, 2,4-diaminophenyl ethyl formate, 3,5-diaminophenyl ethyl formate, 2,4-diaminophenyl propyl formate, 3,5-diaminophenyl propyl formate, 1-dodecoxy-2,4-diaminobenzene, 1-hexadecoxy-2,4-diaminobenzene, 1-octadecoxy-2,4-diaminobenzene, at least one of the compounds represented by formula (II-1-1) to formula (II-1-6), or a combination of the compounds.

The compounds represented by formula (II-1-1) to formula (II-1-6) are as shown below.

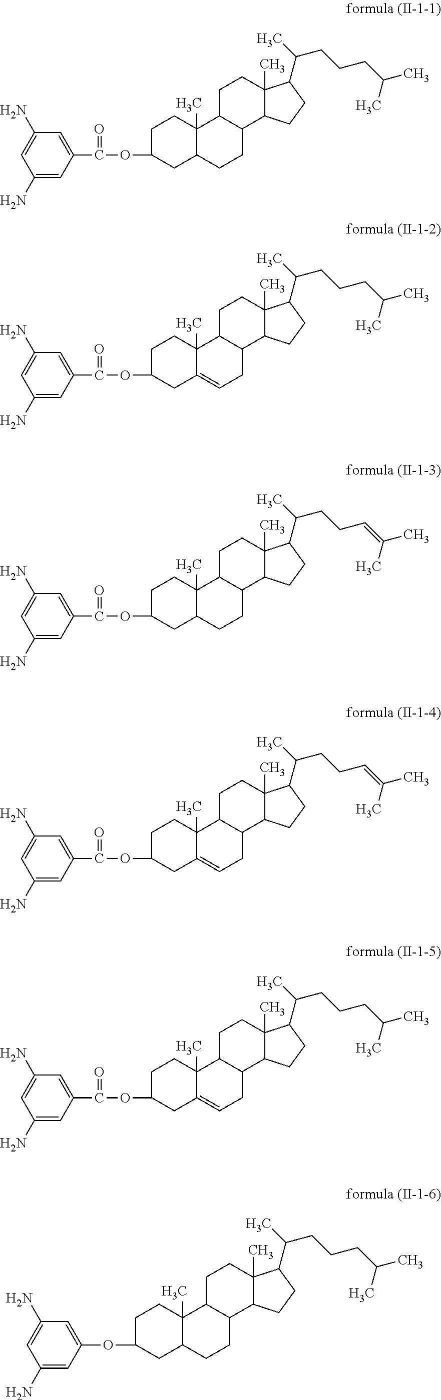

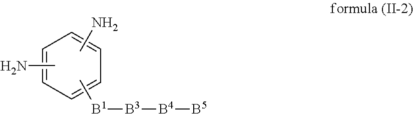

In formula (II-2), B¹ is the same as the B¹ in formula (II-1), B³ and B⁴ each independently represent a divalent aliphatic ring, a divalent aromatic ring, or a divalent heterocyclic group; B⁵ represents a C₃ to C₁₈ alkyl group, a C₃ to C₁₈ alkoxy group, a C₁ to C₅ fluoroalkyl group, a C₁ to C₅ fluoroalkyloxy group, a cyano group, or a halogen atom.

Specific examples of the compound represented by formula (II-2) include at least one of the compounds represented by formula (II-2-1) to formula (II-2-13). Specifically, the compounds represented by formula (II-2-1) to formula (II-2-13) are as follows.

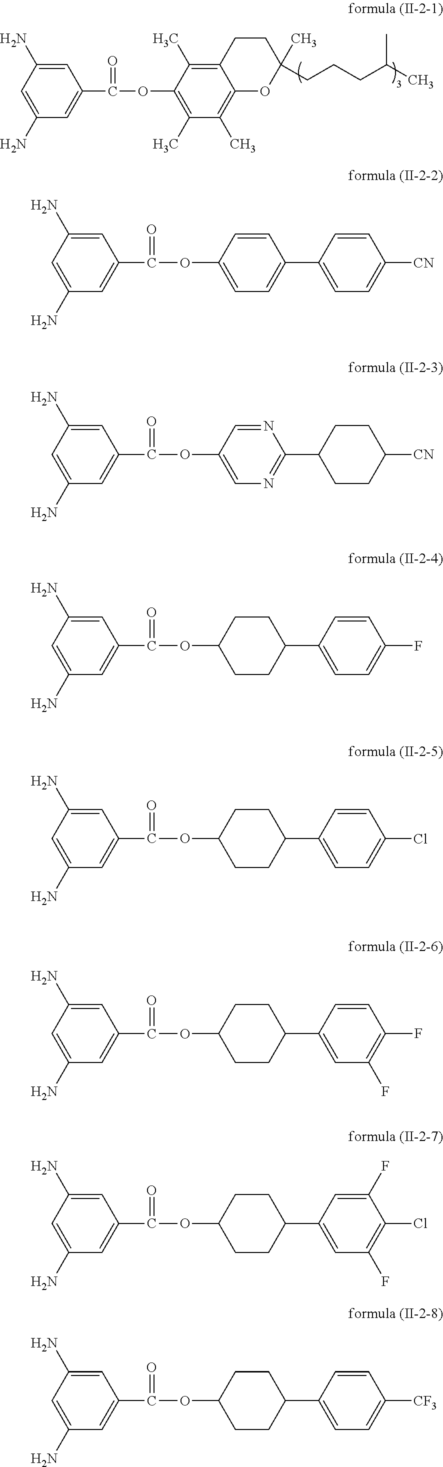

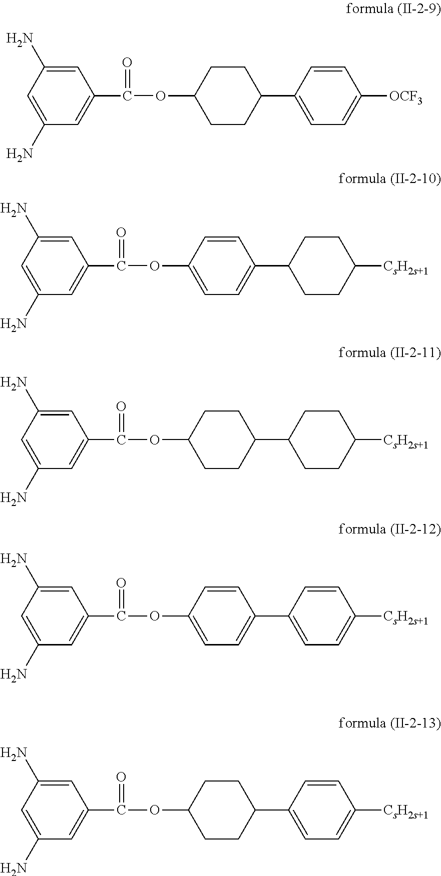

In formula (II-2-10) to formula (II-2-13), s represents an integer of 3 to 12.

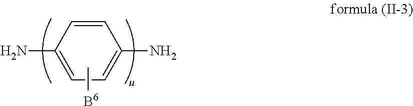

In formula (II-3), B⁶ each independently represents a hydrogen atom, a C₁ to C₅ acyl group, a C₁ to C₅ alkyl group, a C₁ to C₅ alkoxy group, or a halogen atom, and B⁶ in each repeating unit can be the same or different; and u represents an integer of 1 to 3.

Specific examples of the compound represented by formula (II-3) include: when u is 1: p-diaminobenzene, m-diaminobenzene, o-diaminobenzene, or 2,5-diaminotoluene . . . etc.; when u is 2: 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, or 4,4′-diamino-2,2′-bis(trifluoromethyl) biphenyl . . . etc.; or when u is 3: 1,4-bis(4′-aminophenyl)benzene . . . etc.

Specific examples of the compound represented by formula (II-3) preferably include p-diaminobenzene, 2,5-diaminotoluene, 4,4′-diaminobiphenyl, 3,3′-dimethoxy-4,4′-diaminobiphenyl, 1,4-bis(4′-aminophenyl)benzene, or a combination of the compounds.

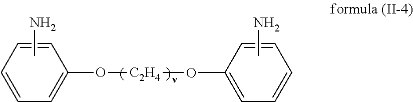

In formula (II-4), v represents an integer of 2 to 12.

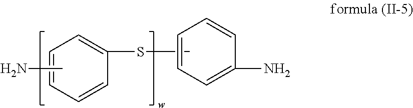

In formula (II-5), w represents an integer of 1 to 5. The compound represented by formula (II-5) is preferably 4,4′-diamino-diphenyl sulfide.

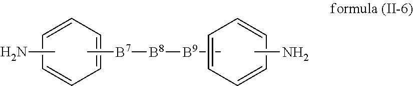

In formula (II-6), B⁷ and B⁹ each independently represent a divalent organic group, and B⁷ and B⁹ can be the same or different; B⁸ represents a divalent group of a cyclic structure containing a nitrogen atom derived from, for instance, pyridine, pyrimidine, triazine, piperidine, or piperazine.

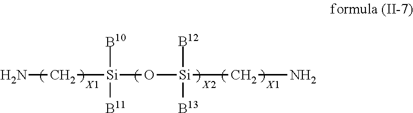

In formula (II-7), B¹⁰, B¹¹, B¹², and B¹³ each independently represent a C₁ to C₁₂ hydrocarbon group, and B¹⁰, B¹¹, B¹², and B¹³ can be the same or different; X1 each independently represents an integer of 1 to 3; and X2 represents an integer of 1 to 20.

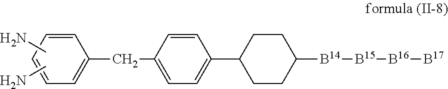

In formula (II-8), B¹⁴ represents an oxygen atom or a cyclohexylene group; B¹⁵ represents a methylene group (—CH₂); B¹⁶ represents a phenylene group or a cyclohexylene group; and B¹⁷ represents a hydrogen atom or a heptyl group.

Specific examples of the compound represented by formula (II-8) include a compound represented by formula (II-8-1), a compound represented by formula (II-8-2), or a combination of the compounds.

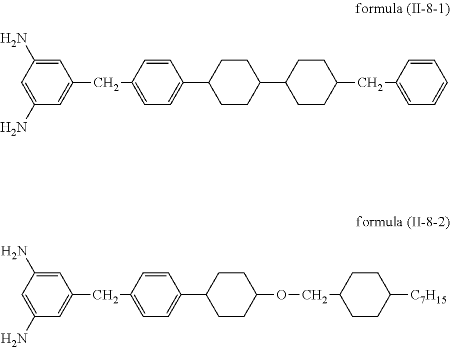

The compounds represented by formula (II-9) to formula (II-30) are as shown below.

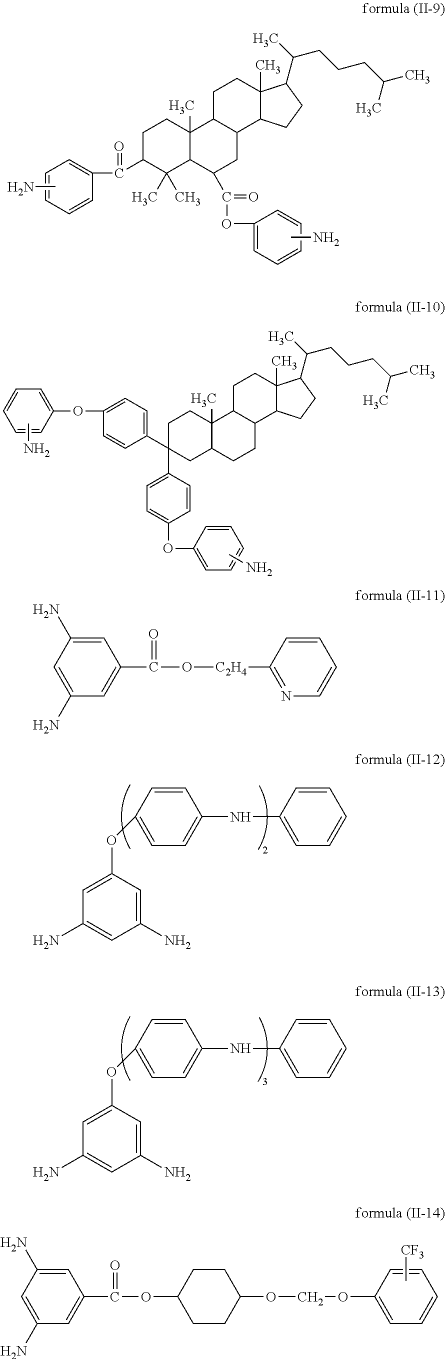

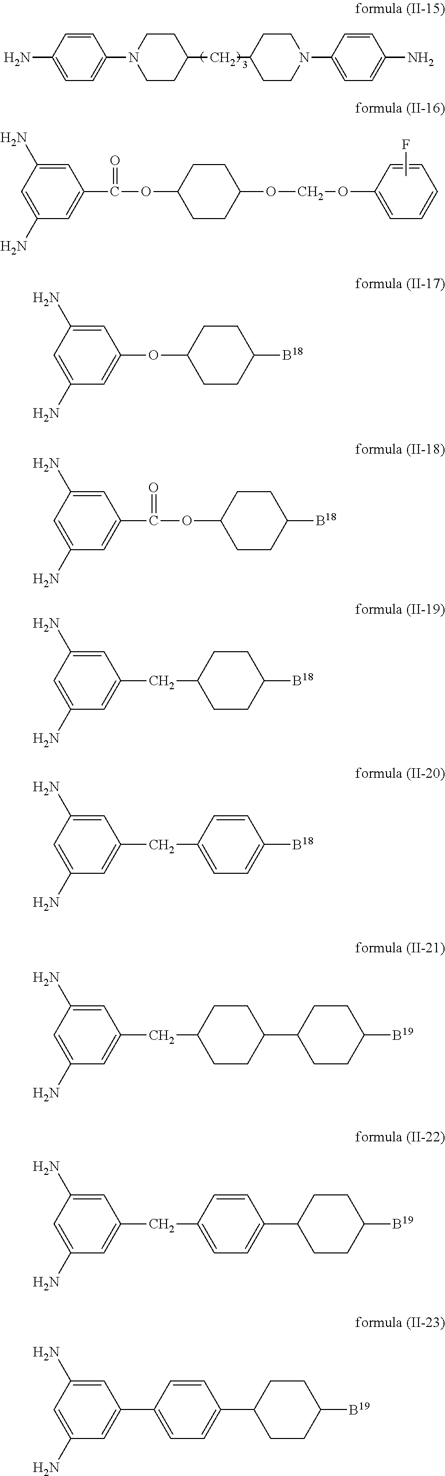

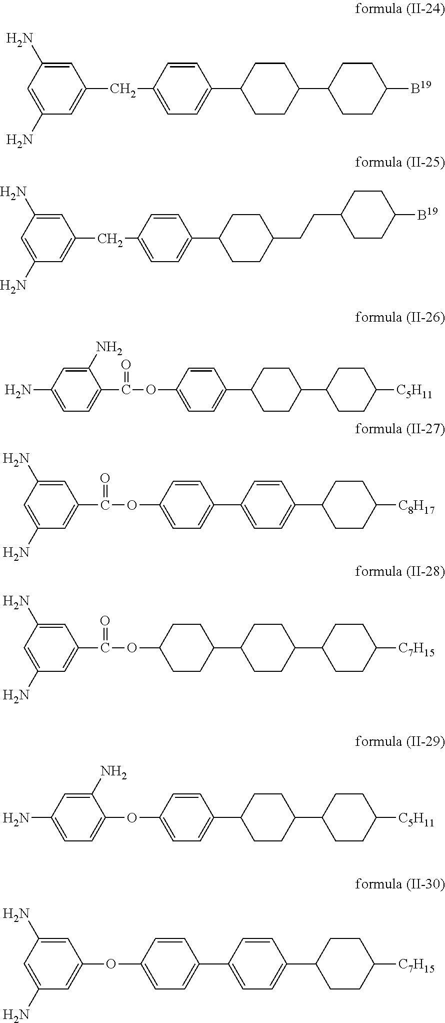

In formula (II-17) to formula (II-25), B¹⁸ preferably represents a C₁ to C₁₀ alkyl group or a C₁ to C₁₀ alkoxy group; B¹⁹ preferably represents a hydrogen atom, a C₁ to C₁₀ alkyl group, or a C₁ to C₁₀ alkoxy group.

The diamine compound (a2-2) can be used alone or in multiple combinations.

Specific examples of the diamine compound (a2-2) preferably include, but are not limited to, 1,2-diaminoethane, 3,3′-diaminochalcone, 4,4′-diaminostilbene, 4,4′-diaminodicyclohexylmethane, 4,4′-diaminodiphenylmethane, 4,4′-diamino diphenylether, 5-[4-(4-n-pentylcyclohexyl)cyclohexyl]phenylmethylene-1,3-diaminobenzene, 1, 1-bis[4-(4-aminophenoxy)phenyl]-4-(4-ethylphenyl)cyclohexane, 2,4-diaminophenyl ethyl formate, 1-octadecoxy-2,4-diaminobenzene, a compound represented by formula (II-1-1), a compound represented by formula (II-1-2), a compound represented by formula (II-1-4), a compound represented by formula (II-1-5), a compound represented by formula (II-2-1), a compound represented by formula (II-2-11), p-diaminobenzene, m-diaminobenzene, o-diaminobenzene, a compound represented by formula (II-8-1), compounds represented by formula (II-26) to formula (II-30), or a combination of the compounds.

Based on a usage amount of 100 moles of the diamine component (a2), the usage amount of the diamine compound (a2-2) can be 80 moles to 95.5 moles, preferably 85 moles to 99.2 moles, more preferably 90 moles to 99 moles.

When the polymer (A) in the liquid crystal alignment agent contains at least one of the diamine compounds (a2-2) represented by formula (II-1), formula (II-2), and formula (II-26) to formula (II-30), the pre-tilt angle light stability of the liquid crystal display element can be further increased.

### Method of Preparing Polymer (A)

The polymer (A) can include at least one of polyamic acid and polyimide. Moreover, the polymer (A) can further include a polyimide-based block copolymer. The preparation method of each of the various polymers above is further described below.

### Method of Preparing Polyamic Acid

The method of preparing the polyamic acid includes first dissolving a mixture in a solvent, wherein the mixture includes the tetracarboxylic dianhydride component (a1) and the diamine component (a2). A polycondensation reaction is then performed at a temperature of 0° C. to 100° C. After reacting for 1 hour to 24 hours, the reaction solution is distilled under reduced pressure with an evaporator to obtain the polyamic acid. Alternatively, the reaction solution is poured into a large amount of a poor solvent to obtain a precipitate. Then, the precipitate is dried with a method of drying under reduced pressure to obtain the polyamic acid.

The solvent used in the polycondensation reaction can be the same as or different from the solvent in the liquid crystal alignment agent below, and the solvent used in the polycondensation reaction is not particularly limited, provided the solvent can dissolve the reactants and the products. The solvent preferably includes, but is not limited to (1) an aprotic polar solvent such as N-methyl-2-pyrrolidinone (NMP), N,N-dimethyl acetamide, N,N-dimethyl formamide, dimethyl sulfoxide, γ-butyrolactone, tetramethylurea, or hexamethylphosphor amide; or (2) a phenolic solvent such as m-cresol, xylenol, phenol, or halogenated phenol. Based on a total usage amount of 100 parts by weight of the mixture, the usage amount of the solvent used in the polycondensation reaction is preferably 200 parts by weight to 2000 parts by weight, more preferably 300 parts by weight to 1800 parts by weight.

It should be mentioned that, in the polycondensation reaction, the solvent can be used with a suitable amount of a poor solvent, wherein the poor solvent does not cause precipitation of the polyamic acid. The poor solvent can be used alone or in multiple combinations, and includes, but is not limited to (1) an alcohol such as methanol, ethanol, isopropanol, cyclohexanol, ethylene glycol, propylene glycol, 1,4-butanediol, or triglycol; (2) a ketone such as acetone, methyl ethyl ketone, methyl isobutyl ketone, or cyclohexanone; (3) an ester such as methyl acetate, ethyl acetate, butyl acetate, diethyl oxalate, diethyl malonate, or ethylene glycol monoethyl ether acetate; (4) an ether such as diethyl ether, ethylene glycol monomethyl ether, ethylene glycol monoethyl ether, ethylene glycol n-propyl ether, ethylene glycol isopropyl ether, ethylene glycol n-butyl ether, ethylene glycol dimethyl ether, or diethylene glycol dimethyl ether; (5) a halogenated hydrocarbon such as dichloromethane, 1,2-dichloro ethane, 1,4-dichlorobutane, trichloroethane, chlorobenzene, or o-dichlorobenzene; or (6) a hydrocarbon such as tetrahydrofuran, hexane, heptane, octane, benzene, toluene, or xylene, or any combination of the solvents. Based on a usage amount of 100 parts by weight of the diamine component (b), the usage amount of the poor solvent is preferably 0 parts by weight to 60 parts by weight, more preferably 0 parts by weight to 50 parts by weight.

### Method of Preparing Polyimide

The method of preparing the polyimide includes heating the polyamic acid obtained by the above method of preparing polyamic acid in the presence of a dehydrating agent and a catalyst. During the heating process, the amic acid functional group in the polyamic acid can be converted into an imide functional group through a cyclodehydration reaction (i.e., imidization).

The solvent used in the cyclodehydration reaction can be the same as the solvent (B) in the liquid crystal alignment agent and is therefore not repeated herein. Based on a usage amount of 100 parts by weight of the polyamic acid, the usage amount of the solvent used in the cyclodehydration reaction is preferably 200 parts by weight to 2000 parts by weight, more preferably 300 parts by weight to 1800 parts by weight.

To obtain a preferable degree of imidization of the polyamic acid, the operating temperature of the cyclodehydration reaction is preferably 40° C. to 200° C., more preferably 40° C. to 150° C. If the operating temperature of the cyclodehydration reaction is less than 40° C., then the imidization reaction is incomplete, and the degree of imidization of the polyamic acid is thereby reduced. However, if the operating temperature of the cyclodehydration reaction is higher than 200° C., then the weight-average molecular weight of the obtained polyimide is lower.

The dehydrating agent used in the cyclodehydration reaction can be selected from an anhydride compound, and specific examples thereof include, for instance, acetic anhydride, propionic anhydride, or trifluoroacetic anhydride. Based on 1 mole of the polyamic acid, the usage amount of the dehydrating agent is 0.01 moles to 20 moles. The catalyst used in the cyclodehydration reaction can be selected from (1) a pyridine compound such as pyridine, trimethyl pyridine, or dimethyl pyridine; or (2) a tertiary amine compound such as triethylamine. Based on a usage amount of 1 mole of the dehydrating agent, the usage amount of the catalyst can be 0.5 moles to 10 moles.

The imidization ratio of the polymer (A) can be 3% to 50%, preferably 4% to 40%, and more preferably 5% to 30%. When the imidization ratio of the polymer (A) in the liquid crystal alignment agent is within the above ranges, the pre-tilt angle light stability of the liquid crystal display element can be further increased.

### Method of Preparing Polyimide-Based Block Copolymer

The polyimide-based block copolymer is selected from a polyamic acid block copolymer, a polyimide block copolymer, a polyamic acid-polyimide block copolymer, or any combination of the polymers.

The method of preparing the polyimide-based block copolymer preferably includes first dissolving a starting material in a solvent and then performing a polycondensation reaction, wherein the starting material includes at least one type of polyamic acid and/or at least one type of polyimide, and can further include a carboxylic anhydride component and a diamine component.

The carboxylic anhydride component and the diamine component in the starting material can be the same as the tetracarboxylic dianhydride component (a1) and the diamine component (a2) used in the method of preparing the polyamic acid. Moreover, the solvent used in the polycondensation reaction can be the same as the solvent in the liquid crystal alignment agent below and is not repeated herein.

Based on a usage amount of 100 parts by weight of the starting material, the usage amount of the solvent used in the polycondensation reaction is preferably 200 parts by weight to 2000 parts by weight, more preferably 300 parts by weight to 1800 parts by weight. The operating temperature of the polycondensation reaction is preferably 0° C. to 200° C., more preferably 0° C. to 100° C.

The starting material preferably includes, but is not limited to (1) two polyamic acids for which the terminal groups are different and the structures are different; (2) two polyimides for which the terminal groups are different and the structures are different; (3) a polyamic acid and a polyimide for which the terminal groups are different and the structures are different; (4) a polyamic acid, a carboxylic anhydride component, and a diamine component, wherein the structure of at least one of the carboxylic anhydride component and the diamine component is different from the structures of the carboxylic anhydride component and the diamine component used to form the polyamic acid; (5) a polyimide, a carboxylic anhydride component, and a diamine component, wherein the structure of at least one of the carboxylic anhydride component and the diamine component is different from the structures of the carboxylic anhydride component and the diamine component used to form the polyimide; (6) a polyamic acid, a polyimide, a carboxylic anhydride component, and a diamine component, wherein the structure of at least one of the carboxylic anhydride component and the diamine component is different from the structures of the carboxylic anhydride component and the diamine component used to form the polyamic acid or the polyimide; (7) two polyamic acids having different structures, a carboxylic anhydride component, and a diamine component; (8) two polyimides having different structures, a carboxylic anhydride component, and a diamine component; (9) two polyamic acids having anhydride groups as terminal groups and having different structures, and a diamine component; (10) two polyamic acids having amine groups as terminal groups and having different structures, and a carboxylic anhydride component; (11) two polyimides having anhydride groups as terminal groups and having different structures, and a diamine component; or (12) two polyimides having amine groups as terminal groups and having different structures, and a carboxylic anhydride component.

Without affecting the efficacy of the invention, the polyamic acid, the polyimide, and the polyimide-based block copolymer are preferably terminal-modified polymers in which molecular weight regulation is first performed. By using the terminal-modified polymers, the coating performance of the liquid crystal alignment agent can be improved. The method of preparing the terminal-modified polymers can include adding a monofunctional compound at the same time a polycondensation reaction is performed on the polyamic acid.

Specific examples of the monofunctional compound include, but are not limited to, (1) a monoanhydride such as maleic anhydride, phthalic anhydride, itaconic anhydride, n-decyl succinic anhydride, n-dodecyl succinic anhydride, n-tetradecyl succinic anhydride, or n-hexadecyl succinic anhydride; (2) a monoamine compound such as aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, or n-eicosylamine; or (3) a monoisocyanate compound such as phenyl isocyanate or naphthyl isocyanate.

In the polymer (A) of the invention, the polystyrene-equivalent weight average molecular weight obtained according to gel permeation chromatography (GPC) is 2,000 to 200,000, preferably 3,000 to 100,000, and more preferably 4,000 to 50,000.

### Photosensitive Polysiloxane (B)

The photosensitive polysiloxane (B) is obtained by reacting a polysiloxane (b1) and a cinnamic acid derivative (b2). In the following, specific examples and synthesis methods of the polysiloxane (b1) and the cinnamic acid derivative (b2) are described.

### Polysiloxane (b1)

The polysiloxane (b1) can be formed by the self-polycondensation of the silane compound (b1-1) containing an epoxy group; or formed by the copolycondensation of the silane compound (b1-1) containing an epoxy group and other silane compounds (b1-2).

Silane Compound (b1-1) Containing an Epoxy Group

The group containing an epoxy group contained in the silicon compound (b1-1) containing an epoxy group includes at least one of a group represented by formula (2-1), a group represented by formula (2-2), and a group represented by formula (2-3).

Specifically, the group represented by formula (2-1) is as shown below.

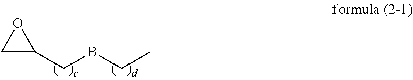

In formula (2-1), B represents an oxygen atom or a single bond; c represents an integer of 1 to 3; d represents an integer of 0 to 6, wherein when d represents 0, B is a single bond.

Moreover, the group represented by formula (2-2) is as shown below.

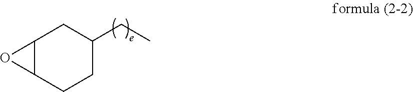

In formula (2-2), e represents an integer of 0 to 6.

The group represented by formula (2-3) is as shown below.

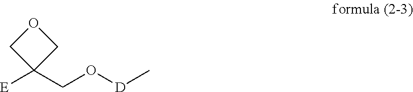

In formula (2-3), D represents a C₂ to C₆ alkylene group; E represents a hydrogen atom or a C₁ to C₆ alkyl group.

The group containing an epoxy group contained in the silane compound (b1-1) containing an epoxy group is, for instance, a glycidyl group, a glycidyloxy group, an epoxycyclohexyl group, or an oxetanyl group.

Specifically, the group containing an epoxy group can include at least one of a group represented by formula (2-1), a group represented by formula (2-2), and a group represented by formula (2-3).

The group containing an epoxy group preferably includes at least one of a group represented by formula (2-1-1), a group represented by formula (2-2-2), and a group represented by formula (2-3-1).

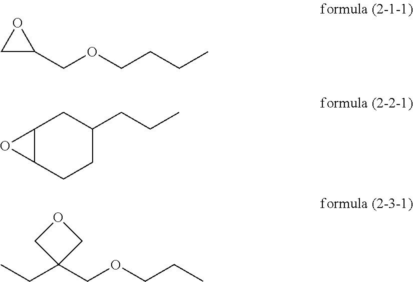

Specific examples of the silane compound (b1-1) containing an epoxy group include 3-(N,N-diglycidyl)aminopropyltrimethoxysilane, 3-(N-allyl-N-glycidyl) aminopropyltrimethoxysilane, 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-glycidoxypropyldimethylmethoxysilane, 3-glycidoxypropyldimethylethoxysilane, 2-glycidoxyethyltrimethoxysilane, 2-glycidoxyethyltriethoxysilane, 2-glycidoxyethylmethyldimethoxysilane, 2-glycidoxyethylmethyldiethoxysilane, 2-glycidoxyethyldimethylmethoxysilane, 2-glycidoxyethyldimethylethoxysilane, 4-glycidoxybutyltrimethoxysilane, 4-glycidoxybutyltriethoxysilane, 4-glycidoxybutylmethyldimethoxysilane, 4-glycidoxybutylmethyldiethoxysilane, 4-glycidoxybutyldimethylmethoxysilane, 4-glycidoxybutyldimethylethoxysilane, 2-(3,4-epoxycyclohexyl)ethyltrimethoxysilane, 2-(3,4-epoxycyclohexyl)ethyltriethoxysilane, 3-(3,4-epoxycyclohexyl)propyltrimethoxysilane, 3-(3,4-epoxycyclohexyl)propyltriethoxysilane, ((3-ethyl-3-oxetanyl)methoxy)propyltrimethoxysilane, ((3-ethyl-3-oxetanyl)methoxy)propyltriethoxysilane, ((3-ethyl-3-oxetanyl)methoxy)propylmethyldimethoxysilane, ((3-ethyl-3-oxetanyl)methoxy)propyldimethylmethoxysilane, commercial products such as DMS-E01, DMS-E12, DMS-E21, and EMS-32 (made by JNC), or a combination of the compounds.

Specific examples of the silane compound (b1-1) containing an epoxy group preferably include 3-glycidoxypropyltrimethoxysilane, 2-glycidoxyethyl trimethoxysilane, 4-glycidoxybutyltrimethoxysilane, 2-(3,4-epoxycyclohexyl)ethyl trimethoxysilane, 2-(3,4-epoxycyclohexyl)ethyltriethoxysilane, ((3-ethyl-3-oxetanyl) methoxy)propyltrimethoxysilane, ((3-ethyl-3-oxetanyl)methoxy)propyltriethoxysilane, DMS-E01, DMS-E12, or a combination of the compounds.

Based on a usage amount of 1.0 mole of the polysiloxane (b1), the usage amount of the silane compound (b1-1) containing an epoxy group is 0.3 moles to 1 mole, preferably 0.35 moles to 0.95 moles, and more preferably 0.4 moles to 0.9 moles.

Other Silane Compounds (b1-2)

The other silane compounds (b1-2) are, for instance, a compound having one silicon atom. The compound having one silicone atom includes a silane compound having four hydrolyzable groups, a silane compound having three hydrolyzable groups, a silane compound having two hydrolyzable groups, a silane compound having one hydrolyzable group, or a combination thereof.

Specific examples of the silane compound having four hydrolyzable groups include tetrachlorosilane, tetramethoxysilane, tetraethoxysilane, tetra-n-propoxysilane, tetraisopropoxysilane, tetra-n-butoxysilane, tetra-sec-butoxysilane, or a combination of the compounds.

Specific examples of the silane compound having three hydrolyzable groups include trichlorosilane, trimethoxysilane, triethoxysilane, fluorotrichlorosilane, fluorotrimethoxysilane, fluorotriethoxysilane, methyltrichlorosilane, methyltrimethoxysilane, methyltriethoxysilane, 2-(trifluoromethyl)ethyltrichlorosilane, 2-(trifluoromethyl)ethyltrimethoxysilane, 2-(trifluoromethyl)ethyltriethoxysilane, hydroxymethyltrichlorosilane, hydroxymethyltrimethoxysilane, hydroxyethyl trimethoxysilane, mercaptomethyltrichlorosilane, 3-mercaptopropyltrichlorosilane, mercaptomethyltrimethoxysilane, mercaptomethyltriethoxysilane, 3-mercaptopropyl trimethoxysilane, 3-mercaptopropyltriethoxysilane, phenyltrichlorosilane, phenyltrimethoxysilane, phenyltriethoxysilane, or a combination of the compounds.

Specific examples of the silane compound having two hydrolyzable groups include methyldichlorosilane, methyl dimethoxysilane, methyldiethoxysilane, dimethyldichlorosilane, dimethyldimethoxysilane, dimethyldiethoxysilane, methyl[2-(perfluoro-n-octyl)ethyl]dichlorosilane, methyl[2-(perfluoro-n-octyl)ethyl]dimethoxysilane, 3-mercaptopropylmethyldichlorosilane, 3-mercaptopropyl methyldimethoxysilane, diphenyldichlorosilane, diphenyldimethoxysilane, or a combination of the compounds.

Specific examples of the silane compound having one hydrolyzable group include chlorodimethylsilane, methoxydimethylsilane, chlorotrimethylsilane, bromotrimethylsilane, iodotrimethylsilane, methoxytrimethylsilane, chloromethyldiphenylsilane, methoxymethyldiphenylsilane, or a combination of the compounds.

Specific examples of commercial products of the other silane compounds (b1-2) can include, for instance, KC-89, KC-89S, X-21-3153, X-21-5841, X-21-5842, X-21-5843, X-21-5844, X-21-5845, X-21-5846, X-21-5847, X-21-5848, X-22-160AS, X-22-170B, X-22-170BX, X-22-170D, X-22-170DX, X-22-176B, X-22-176D, X-22-176DX, X-22-176F, X-40-2308, X-40-2651, X-40-2655A, X-40-2671, X-40-2672, X-40-9220, X-40-9225, X-40-9227, X-40-9246, X-40-9247, X-40-9250, X-40-9323, X-41-1053, X-41-1056, X-41-1805, X-41-1810, KF6001, KF6002, KF6003, KR212, KR-213, KR-217, KR220 L, KR242A, KR271, KR282, KR300, KR311, KR401N, KR500, KR510, KR5206, KR5230, KR5235, KR9218, KR9706 (made by Shin-Etsu Chemical); glass resin (made by Showa Denko); SH804, SH805, SH806A, SH840, SR2400, SR2402, SR2405, SR2406, SR2410, SR2411, SR2416, SR2420 (made by Dow Corning Toray); FZ3711, FZ3722 (made by NUC); DMS-S12, DMS-S15, DMS-S21, DMS-527, DMS-S31, DMS-532, DMS-S33, DMS-S35, DMS-538, DMS-S42, DMS-545, DMS-551, DMS-227, PSD-0332, PDS-1615, PDS-9931, XMS-5025 (made by JNC); MS51, MS56 (made by Mitsubishi Chemical); and partial condensates of GR100, GR650, GR908, GR950 (made by Showa Denko).

The other silane compounds (b1-2) are preferably tetramethoxysilane, tetraethoxysilane, methyltrimethoxysilane, methyltriethoxysilane, phenyltrimethoxy silane, phenyltriethoxysilane, 3-mercaptopropyltrimethoxysilane, 3-mercaptopropyl triethoxysilane, mercaptomethyltrimethoxysilane, mercaptomethyltriethoxysilane, dimethyldimethoxysilane, dimethyldiethoxysilane, or a combination of the compounds.

Based on a usage amount of 1.0 mole of the polysiloxane (b1), the usage amount of the other silane compounds (b1-2) is 0 moles to 0.7 moles, preferably 0.05 moles to 0.65 moles, and more preferably 0.1 moles to 0.6 moles.

### Preparation Method of Polysiloxane (b1)

The polycondensation reaction forming the polysiloxane compound containing an epoxy group can include a general method such as adding an organic solvent or water in the silane compound or a mixture thereof, or optionally further adding a catalyst thereto, and then performing heating via, for instance, an oil bath at 50° C. to 150° C., and the heating time is preferably 0.5 hours to 120 hours. During heating, the mixed solution can be stirred, and can also be placed under a reflux condition.

The organic solvent is not particularly limited, and can be the same as or different from the solvent (C) contained in the liquid crystal alignment agent of the invention.

Specific examples of the organic solvent include a hydrocarbon compound such as toluene or xylene; a ketone solvent such as methyl ethyl ketone, methyl isobutyl ketone, methyl-n-pentyl ketone, diethyl ketone, cyclohexanone, 2-butanone, or 2-hexanone; an ester solvent such as ethyl acetate, n-butyl acetate, isopentyl acetate, propylene glycol monomethyl ether acetate, 3-methoxybutyl acetate, or ethyl lactate; an ether solvent such as ethylene glycol dimethyl ether, ethylene glycol diethyl ether, tetrahydrofuran, or dioxane; an alcohol solvent such as 1-hexanol, 4-methyl-2-pentanol, ethylene glycol monomethyl ether, ethylene glycol monoethyl ether, ethylene glycol mono-n-propyl ether, ethylene glycol mono-n-butyl ether, propylene glycol monomethyl ether, propylene glycol monoethyl ether, or propylene glycol mono-n-propyl ether; an amide solvent such as N-methyl-2-pyrrolidone, N,N-dimethylacetamide, N,N-dimethylformamide, hexamethylphosphoric triamide, or 1,3-dimethyl-2-imidazolidinone, or a combination of the organic solvents.

The organic solvents can be used alone or in multiple combinations.

Based on 100 parts by weight of the diamine compound, the usage amount of the organic solvent is preferably 10 parts by weight to 1200 parts by weight, more preferably 30 parts by weight to 1,000 parts by weight.

Based on 1 mole of the hydrolyzable group of all of the silane compounds, the usage amount of water is preferably 0.5 moles to 2 moles.

The catalyst is not particularly limited, and the catalyst is preferably selected from an acid, an alkali metal compound, an organic base, a titanium compound, a zirconium compound, or a combination thereof.

Specific examples of the acid include hydrochloric acid, nitric acid, sulfuric acid, hydrofluoric acid, oxalic acid, phosphoric acid, acetic acid, trifluoroacetic acid, formic acid, polybasic carboxylic acid, polybasic acid anhydride, or a combination thereof.

Specific examples of the alkali metal compound include sodium hydroxide, potassium hydroxide, sodium methoxide, potassium methoxide, sodium ethoxide, potassium ethoxide, or a combination thereof.

Specific examples of the organic base include, for instance, a primary or secondary organic amine such as ethylamine, diethylamine, piperazine, piperidine, pyrrolidine, or pyrrole; a tertiary organic amine such as triethylamine, tri-n-propylamine, tri-n-butylamine, pyridine, 4-dimethylaminopyridine, or diazabicycloundecene; a quaternary organic amine such as tetramethylammonium hydroxide, or a combination of the compounds.

The usage amount of the catalyst is different according to, for instance, reaction conditions such as type or temperature, and can be suitably set. For instance, based on 1 mole of all of the silane compounds, the additive amount of the catalyst is 0.01 moles to 5 moles, preferably 0.03 moles to 3 moles, and more preferably 0.05 moles to 1 mole.

Based on stability concerns, after the polycondensation reaction is complete, the organic solvent layer fractionated from the reaction solution is preferably washed with water. When washing is performed, water containing a small amount of salt is preferably used, such as performing washing with, for instance, an aqueous solution of around 0.2 wt % ammonium nitrate. The washing can be performed until the washed aqueous layer is neutral, and then after the organic solvent layer is dried via a desiccant such as anhydrous calcium sulfate or a molecular sieve as needed, the organic solvent is removed to obtain the polysiloxane (b1).

### Cinnamic Acid Derivative (b2)

The cinnamic acid derivative (b2) is at least one in the group consisting of compounds represented by formula (3-1) to formula (3-2).

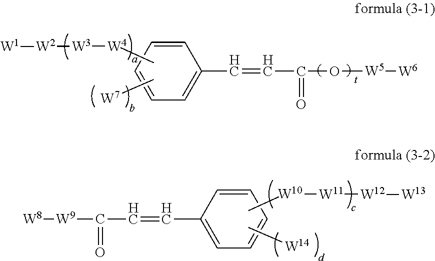

In formula (3-1), W¹ represents a hydrogen atom, a C₁ to C₄₀ alkyl group, or a C₃ to C₄₀ monovalent organic group containing an alicyclic group, wherein a portion of or all of the hydrogen atoms of the alkyl group can be substituted by fluorine atoms; W² represents a single bond, an oxygen atom, —COO—, or —OCO—; W³ represents a divalent aromatic group, a divalent alicyclic group, a divalent heterocyclic group, or a divalent fused-ring group; W⁴ represents a single bond, an oxygen atom, —COO—, or —OCO—; W⁵ represents a single bond, a methylene group, a C₂ to C₁₀ alkylene group, or a divalent aromatic group; when W⁵ represents a single bond, t represents 0, and W⁶ is a hydroxyl group or —SH; when W⁵ represents a methylene group, an alkylene group, or a divalent aromatic group, t represents 0 or 1, and W⁶ is a carboxylic acid group, a hydroxyl group, —SH, —NCO, —NHW, —CH═CH₂, or —SO₂Cl, wherein W represents a hydrogen atom or a C₁ to C₆ alkyl group; W⁷ represents a fluorine atom or a cyano group; a represents an integer of 0 to 3; and b represents an integer of 0 to 4.

In formula (3-2), W⁸ represents a C₁ to C₄₀ alkyl group or a C₃ to C₄₀ monovalent organic group containing an alicyclic group, wherein a portion of or all of the hydrogen atoms of the alkyl group can be substituted by fluorine atoms; W⁹ represents a single bond, an oxygen atom, or a divalent aromatic group; W¹⁰ represents an oxygen atom, —COO—, or —OCO—; W¹¹ represents a divalent aromatic group, a divalent heterocyclic group, or a divalent fused-ring group; W¹² represents a single bond, —OCO—(CH₂)ₑ—*, or —O—(CH₂)_{g}—*, wherein e and g each independently represent an integer of 1 to 10, and * each independently represents a bond with W¹³; W¹³ represents a carboxylic acid group, a hydroxyl group, —SH, —NCO, —NHW, —CH═CH₂, or —SO₂Cl, wherein W represents a hydrogen atom or a C₁ to C₆ alkyl group; W¹⁴ represents a fluorine atom or a cyano group; c represents an integer of 0 to 3; and d represents an in integer of 0 to 4.

W¹ in formula (3-1) is a C₁ to C₄₀ alkyl group, and is preferably a C₁ to C₂₀ alkyl group, wherein a portion of or all of the hydrogen atoms of the alkyl group can be substituted by fluorine atoms. Specific examples of the alkyl group can include, for instance, n-pentyl, n-hexyl, n-heptyl, n-octyl, n-nonyl, n-decyl, n-lauryl, n-dodecyl, n-tridecyl, n-tetradecyl, n-pentadecyl, n-hexadecyl, n-heptadecyl, n-octadecyl, n-nonadecyl, n-eicosyl, 4,4,4-trifluorobutyl, 4,4,5,5,5-pentafluoropentyl, 4,4,5,5,6,6,6-heptafluorohexyl, 3,3,4,4,5,5,5-heptafluoropentyl, 2,2,2-trifluoroethyl, 2,2,3,3,3-pentafluoropropyl, 2-(perfluorobutyl)ethyl, 2-(perfluorooctyl)ethyl, and 2-(perfluorodecyl)ethyl. In W¹, the C₃ to C₄₀ monovalent organic group containing an alicyclic group can include, for instance, a cholestenyl group, a cholestanyl group, or an adamantyl group.

The divalent aromatic groups of W³ and W⁵ can include, for instance, 1,4-phenylene, 2-fluoro-1,4-phenylene, 3-fluoro-1,4-phenyl ene, or 2,3,5,6-tetrafluoro-1,4-phenylene; the divalent heterocyclic group of W³ can include, for instance, 1,4-pyridylene, 2,5-pyridylene, or 1,4-furylene; the divalent fused-ring group of W³ can include, for instance, a naphthylene group. The divalent alicyclic group of W³ can include, for instance, 1,4-cyclohexylidene.

Specific examples of the compound represented by formula (3-1) include at least one of the compounds represented by formula (3-1-1) to formula (3-1-34).

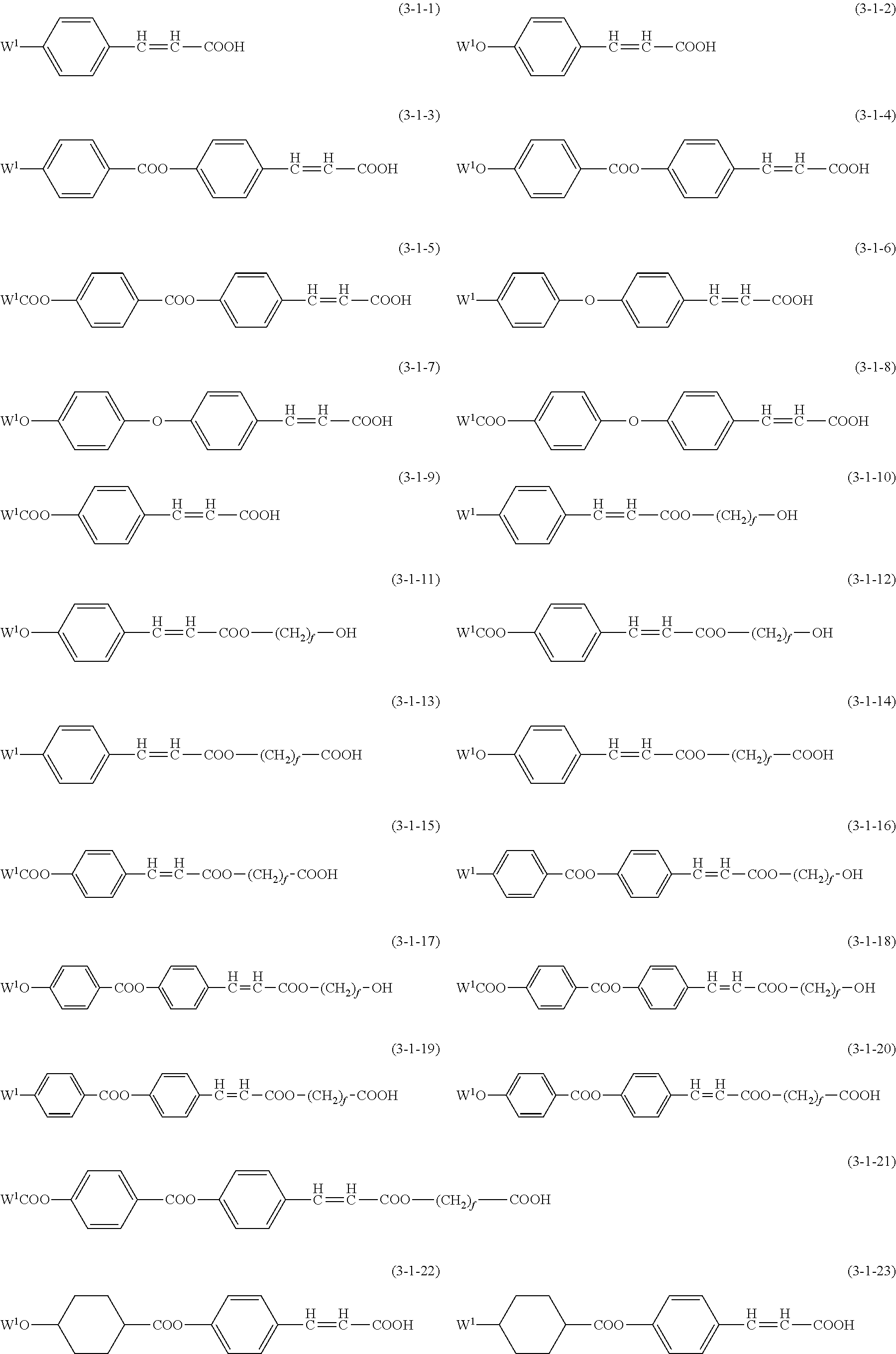

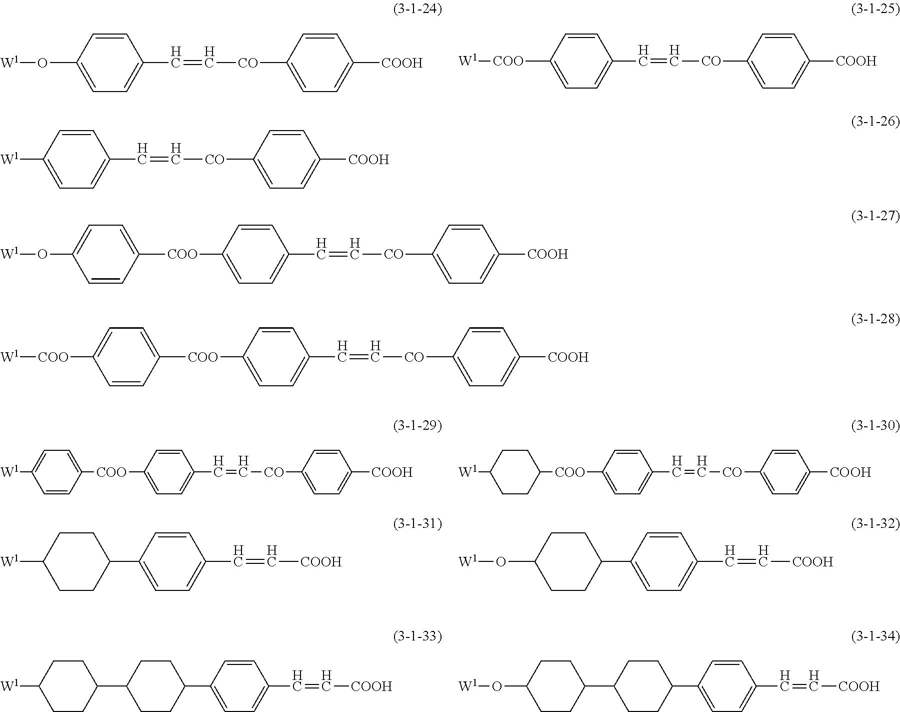

W¹ in formula (3-1-1) to formula (3-1-34) is the same as W¹ represented in formula (3-1), and f represents an integer of 1 to 10.

W⁸ in formula (3-2) is a C₁ to C₄₀ alkyl group, and is preferably, for instance, a C₁ to C₂₀ alkyl group, wherein a portion of or all of the hydrogen atoms of the alkyl group can be substituted by fluorine atoms. Examples of the alkyl group can include, for instance, the alkyl groups of W¹ in formula (3-1). The C₃ to C₄₀ monovalent organic group containing an alicyclic group of W⁸ can include, for instance, a cholestenyl group, a cholestanyl group, or an adamantyl group.

The divalent aromatic group, the heterocyclic group, or the fused-ring group of W⁹ and W¹¹ can include the examples for the divalent aromatic group, the heterocyclic group, or the fused-ring group of W³ and W⁵ in formula (3-1).

Specific examples of the compound represented by formula (3-2) include at least one of the compounds represented by formula (3-2-1) to formula (3-2-11).

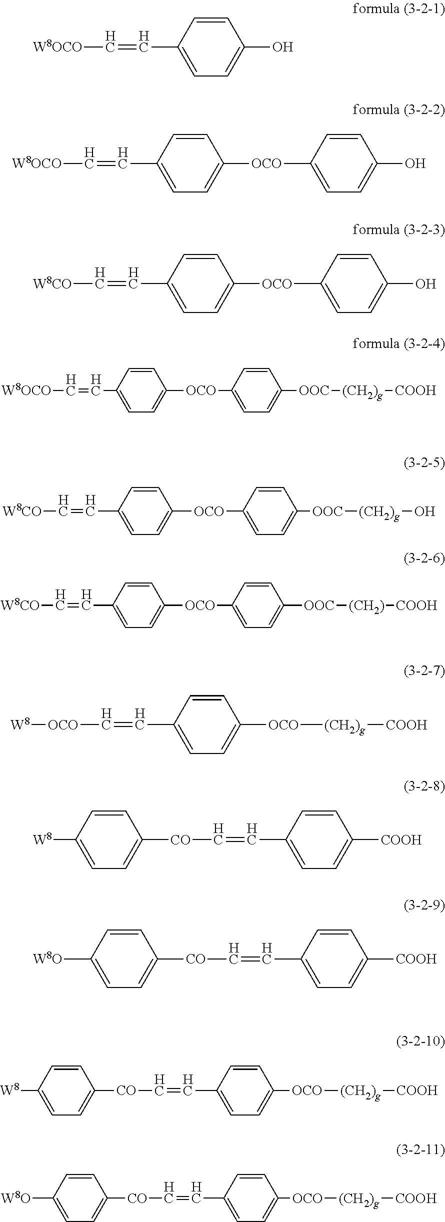

W⁸ in formula (3-2-1) to formula (3-2-11) is the same as W⁸ represented in formula (3-2), and g represents an integer of 1 to 10.

Moreover, without compromising the effect of the invention, a portion of the cinnamic acid derivative can be substituted by the compound represented by the following formula (4).

W¹⁵—W¹⁶—W¹⁷ formula (4)

In formula (4), W¹⁵ represents a C₄ to C₂₀ alkyl group or alkoxy group, or a C₃ to C₄₀ monovalent organic group containing an alicyclic group, wherein a portion of or all of the hydrogen atoms of the alkyl group or the alkoxy group can be substituted by fluorine atoms; W¹⁶ represents a single bond or a phenylene group, wherein when W¹⁵ is an alkoxy group, W¹⁶ is a phenylene group; W¹⁷ represents a carboxylic acid group, a hydroxyl group, —SH, —NCO, or —NHW, wherein W represents a hydrogen atom or at least one of a C₁ to C₆ alkyl group, —CH═CH₂, and —SO₂Cl.

The cinnamic acid derivative (b2) is preferably a compound represented by formula (3-1-3), (3-1-9), (3-1-11), (3-1-23), (3-1-24), (3-1-30), (3-2-2), (3-2-7), or (3-2-9), or a combination of the compounds.

The molar equivalent ratio (b2)/(b1-1) of the cinnamic acid derivative (b2) and the silane compound (b1-1) containing an epoxy group can be 0.1 to 0.7, preferably 0.2 to 0.6, more preferably 0.3 to 0.5. When the molar equivalent ratio of the cinnamic acid derivative (b2) and the silane compound (b1-1) containing an epoxy group of the photosensitive polysiloxane (B) in the liquid crystal alignment agent is 0.1 to 0.7, the pre-tilt angle light stability of the liquid crystal display element can be further increased.

### Preparation Method of Photosensitive Polysiloxane (B)

The photosensitive polysiloxane in the invention can be synthesized by reacting the polysiloxane (b1) and the cinnamic acid derivative (b2) in the presence of a catalyst.

Without compromising the effect of the invention, a portion of the cinnamic acid derivative can be substituted by the compound represented by formula (4). In this case, the synthesis of the photosensitive polysiloxane can be performed by reacting the polysiloxane (b1) and a mixture of the cinnamic acid derivative (b2) and the compound represented by formula (4).

W¹⁵ in formula (4) is preferably a C₈ to C₂₀ alkyl group or alkoxy group, or a C₄ to C₂₁ fluoroalkyl group or fluoroalkoxy group. W¹⁶ is preferably a single bond, 1,4-cyclohexylidene, or 1,4-phenylene. W¹⁷ is preferably a carboxylic acid group.

Specific examples of the compound represented by formula (4) are preferably, for instance, the compounds represented by formula (4-1) to formula (4-4).

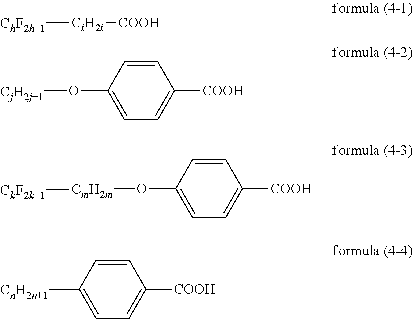

In the formulas, h represents an integer of 1 to 3; i represents an integer of 3 to 18; j represents an integer of 5 to 20; k represents an integer of 1 to 3; m represents an integer of 0 to 18; and n represents an integer of 1 to 18. In particular, the specific examples are preferably the compounds represented by formula (4-3-1) to formula (4-3-3).

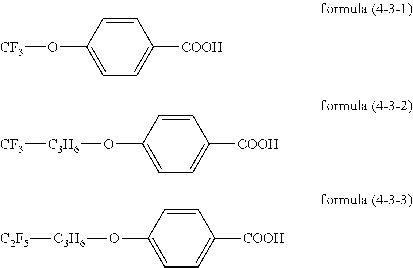

The catalyst can include an organic salt or a known compound such as a curing promoter capable of facilitating the reaction of an epoxy compound and an anhydride.

The organic salt can include, for instance, a primary organic amine or secondary organic amine such as ethylamine, diethylamine, piperazine, piperidine, pyrrolidine, or pyrrole; a tertiary organic amine such as triethylamine, tri-n-propylamine, tri-n-butylamine, pyridine, 4-dimethylaminopyridine, or diazabicyclo undecene; or a quaternary organic amine such as tetramethylammonium hydroxide. Among these organic amines, a tertiary organic amine such as triethylamine, tri-n-propylamine, tri-n-butylamine, pyridine, or 4-dimethylaminopyridine or a quaternary organic amine such as tetramethylammonium hydroxide is preferred.

Specific examples of the curing promoter include, for instance, a tertiary amine such as benzyl dimethylamine, 2,4,6-tris(dimethylaminomethyl)phenol, cyclohexyl dimethylamine, or triethanolamine; an imidazole compound such as 2-methylimidazole, 2-n-heptyl-imidazole, 2-n-alkylimidazole, 2-phenylimidazole, 2-phenyl-4-methylimidazole, 1-benzyl-2-methylimidazole, 1-benzyl-2-phenylimidazole, 1,2-dimethylimidazole, 2-ethyl-4-methylimidazole, 1-(2-cyanoethyl)-2-methylimidazole, 1-(2-cyanoethyl)-2-5-n-undecylimidazole, 1-(2-cyano ethyl)-2-phenylimidazole, 1-(2-cyano ethyl)-2-ethyl-4-methylimidazole, 2-phenyl-4-methyl-5-hydroxymethyl imidazole, 2-phenyl-4,5-bis(hydroxymethypimidazole, 1-(2-cyanoethyl)-2-phenyl-4,5-bis[(2′-cyanoethoxy)methyl]imidazole, 1-(2-cyano ethyl)-2-n-undecanyl imidazolium trimellitate, 1-(2-cyanoethyl)-2-phenyl imidazolium trimellitate, 1-(2-cyanoethyl)-2-ethyl-4-methyl imidazolium trimellitate, 2,4-diamino-6-[2′-methylimidazolyl-(1′)]ethyl-S-triazine, 2,4-diamino-6-(2′-n-undecylimidazolyl)ethyl-S-triazine, 2,4-diamino-6-[2′-ethyl-4′-methylimidazolyl-(1′)]ethyl-S-triazine, an isocyanuric acid adduct of 2-methylimidazole, an isocyanuric acid adduct of 2-phenylimidazole, or an isocyanuric acid adduct of 2,4-diamino-6-[2′-methylimidazolyl-(l′)]ethyl-S-triazine; an organophosphorus compound such as diphenylphosphine, triphenylphosphine, or triphenyl phosphite; a quaternary phosphonium salt such as benzyl triphenyl phosphonium chloride, tetra-n-butyl phosphonium bromide, methyl triphenyl phosphonium bromide, ethyl triphenyl phosphonium bromide, n-butyl triphenylphosphonium bromide, tetraphenylphosphonium bromide, ethyl triphenyl phosphonium iodide, ethyl triphenyl phosphonium acetate, tetra-n-butyl phosphonium-O,O-diethyl phosphorodithionate, tetra-n-butylphosphonium benzotriazolate, tetra-n-butylphosphonium tetrafluoroborate, tetra-n-butyl phosphonium tetraphenylborate, or tetraphenyl phosphonium tetraphenylborate; a diazabicycloalkene such as 1,8-diazabicyclo[5.4.0]undec-7-ene or an organic acid salt thereof; an organometallic compound such as zinc octoate, tin octoate, or aluminium acetylacetone complex; a quaternary ammonium salt such as tetraethyl ammonium bromide, tetra-n-butyl ammonium bromide, tetraethylammonium chloride, or tetra-n-butyl ammonium chloride; a boron compound such as boron trifluoride or triphenyl borate; a metal halogen compound such as zinc chloride or tin tetrachloride; a high-melting point dispersion-type latent curing promoter such as dicyandiamide or an amine addition-type promoter such as an adduct of amine and an epoxy resin; a microcapsule-type latent curing promoter covering the surface of a curing promoter such as the imidazole compound, the organophosphorus compound, or the quaternary phosphonium salt via a polymer; an amine salt-type latent curing promoter; a latent curing promoter such as a high-temperature dissociation-type thermal cationic polymerization latent curing promoter such as a Lewis acid or a Bronsted acid salt.

Specific examples of the curing promoter preferably include a quaternary ammonium salt such as tetraethyl ammonium bromide, tetra-n-butyl ammonium bromide, tetraethyl ammonium chloride, and tetra-n-butyl ammonium chloride.

Based on 100 parts by weight of the polysiloxane (b1), the usage amount of the catalyst is 100 parts by weight or less, preferably 0.01 parts by weight to 100 parts by weight, and more preferably 0.1 parts by weight to 20 parts by weight.

The reaction temperature is preferably 0° C. to 200° C., more preferably 50° C. to 150° C. The reaction time is preferably 0.1 hours to 50 hours, more preferably 0.5 hours to 20 hours.

The synthesis reaction of the photosensitive polysiloxane (B) can be performed in the presence of an organic solvent as needed. The organic solvent is not particularly limited, and can be the same as or different from the organic solvent used in the preparation of the polysiloxane (b1) and the solvent (C) contained in the liquid crystal alignment agent of the invention. Specific examples of the organic solvent are preferably 2-butanone, 2-hexanone, methyl isobutyl ketone, n-butyl acetate, or a combination thereof.

In the polysiloxane (B) of the invention, the polystyrene-equivalent weight average molecular weight obtained according to GPC is 500 to 100,000, preferably 800 to 50,000, and more preferably 1,000 to 20,000.

Based on a total usage amount of 100 parts by weight of the polymer (A), the usage amount of the photosensitive polysiloxane (B) is 3 part by weight to 30 parts by weight, preferably 4 parts by weight to 25 parts by weight, and more preferably 5 parts by weight to 20 parts by weight. When the liquid crystal alignment agent does not include the photosensitive polysiloxane (B), the liquid crystal alignment film has the issue of poor pre-tilt angle light stability.

### Solvent (C)

The solvent used in the liquid crystal alignment agent of the invention is not particularly limited, and only needs to be able to dissolve the polymer (A), the photosensitive polysiloxane (B), and any other components without reacting therewith. The solvent is preferably the same as the solvent used in the synthesis of the polyamic acid, and at the same time, the poor solvent used in the synthesis of the polyamic acid can also be used together.

Specific examples of the solvent (C) include, but are not limited to, for instance, N-methyl-2-pyrrolidone (NMP), γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol monomethyl ether, ethylene glycol monoethyl ether, ethylene glycol n-propyl ether, ethylene glycol isopropyl ether, ethylene glycol n-butyl ether, ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, N,N-dimethyl formamide, or N,N-dimethyl acetamide. The solvent (C) can be used alone or in multiple combinations.

Based on a usage amount of 100 parts by weight of the polymer (A), the usage amount of the solvent (C) is 800 parts by weight to 4000 parts by weight, preferably 900 parts by weight to 3500 parts by weight, and more preferably 1000 parts by weight to 3000 parts by weight.

### Additive (D)

Without affecting the efficacy of the invention, an additive (D) can further optionally be added to the liquid crystal alignment agent, wherein the additive (D) includes a compound having at least two epoxy groups, a silane compound having a functional group, or a combination thereof.

The compound having at least two epoxy groups includes, but is not limited to, ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerol diglycidyl ether, 2,2-dibromo-neopentyl glycol diglycidyl ether, 1,3,5,6-tetraglycidyl-2,4-hexanediol, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, 3-(N,N-diglycidyl) aminopropyltrimethoxysilane, or a combination of the compounds.

The compound having at least two epoxy groups can be used alone or in multiple combinations.

Based on a usage amount of 100 parts by weight of the polymer (A), the usage amount of the compound having at least two epoxy groups can be 0 parts by weight to 40 parts by weight, preferably 0.1 parts by weight to 30 parts by weight.

Specific examples of the silane compound having a functional group include, but are not limited to, 3-aminopropyltrimethoxysilane, 3-aminopropyltriethoxy silane, 2-aminopropyltrimethoxysilane, 2-aminopropyltriethoxysilane, N-(2-amino ethyl)-3-aminopropyltrimethoxysilane, N-(2-amino ethyl)-3-aminopropyl dimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyl triethoxysilane, N-triethoxysilylpropyltriethylenetriamine, N-trimethoxysilylpropyl triethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, N-bis(oxyethylene)-3-aminopropyltriethoxysilane, or a combination of the compounds.

The silane compound having a functional group can be used alone or in multiple combinations.

Based on a usage amount of 100 parts by weight of the polymer (A), the usage amount of the silane compound having a functional group can be 0 parts by weight to 10 parts by weight, preferably 0.5 parts by weight to 10 parts by weight.

Based on a total usage amount of 100 parts by weight of the polymer (A), the usage amount of the additive (D) is preferably 0.5 parts by weight to 50 parts by weight, more preferably 1 part by weight to 45 parts by weight.

### <Preparation Method of Liquid Crystal Alignment Agent>

The preparation method of the liquid crystal alignment agent of the invention is not particularly limited, and a general mixing method can be used for the preparation. For instance, the polymer (A) and the photosensitive polysiloxane (B) formed by the above methods are uniformly mixed to form a mixture. Then, the solvent (C) is added under the condition of a temperature of 0° C. to 200° C. Next, the additive (D) is optionally added, and lastly the mixture is continuously stirred with a stirring apparatus until dissolved. Moreover, the solvent (C) is preferably added at a temperature of 20° C. to 60° C.

At 25° C., the viscosity of the liquid crystal alignment agent of the invention is generally 15 cps to 35 cps, preferably 17 cps to 33 cps, and more preferably 20 cps to 30 cps.

### <Preparation Method of Liquid Crystal Alignment Film>

The liquid crystal alignment agent of the invention is suitable for forming a liquid crystal alignment film through a photoalignment method.

The method of forming the liquid crystal alignment film can include, for instance, a method of coating the liquid crystal alignment agent on a substrate to form a coating film, and irradiating the coating film with polarized or non-polarized radiation from a direction inclined relative to the surface of the coating film; or irradiating the coating film with polarized radiation from a direction perpendicular to the surface of the coating film to provide liquid crystal alignment capability to the coating film.

First, the liquid crystal alignment agent of the invention is coated on one side of a transparent conductive film of a substrate on which a patterned transparent conductive film is disposed through a suitable coating method such as a roll coating method, a spin coating method, a printing method, or an ink-jet method. After coating, a pre-bake treatment is performed on the coating surface, and then a post-bake treatment is performed to form a coating film. The purpose of the pre-bake treatment is to volatilize the organic solvent in the pre-coating layer. The pre-bake treatment is, for instance, performed under the conditions of 0.1 minutes to 5 minutes at 40° C. to 120° C. The post-bake treatment is preferably performed under the condition of 120° C. to 300° C., more preferably 150° C. to 250° C., and is preferably performed for 5 minutes to 200 minutes, more preferably 10 minutes to 100 minutes. The film thickness of the coating film after post-bake is preferably 0.001 μm to 1 μm, more preferably 0.005 μm to 0.5 μm.

The substrate can include, for instance, a transparent substrate formed by a glass such as a float glass or a soda-lime glass; or a plastic such as poly(ethylene terephthalate), poly(butylene terephthalate), polyethersulfone, or polycarbonate.

The transparent conductive film can include, for instance, a NESA film formed by SnO₂ or an ITO (indium tin oxide) film formed by In₂O₃—SnO₂. To form the transparent conductive film patterns, a method such as photo-etching or a method in which a mask is used when the transparent conductive film is formed can be used.

When the liquid crystal alignment agent is coated, to improve the adhesion between the substrate or transparent conductive film and the coating film, a functional silane compound or a titanate compound . . . etc. can be pre-coated on the substrate and the transparent conductive film.

Then, liquid crystal alignment capability is provided by irradiating the coating film with polarized or non-polarized radiation, and the liquid crystal alignment film is formed by the coating film. Here, the radiation can include, for instance, ultraviolet and visible light having a wavelength of 150 nm to 800 nm, and preferably includes ultraviolet having a wavelength of 300 nm to 400 nm. When the radiation used is polarized light (linearly polarized light or partially polarized light), irradiation can be performed from a direction perpendicular to the coating film surface. Moreover, to provide a pre-tilt angle, irradiation can also be performed from an inclined angle. Moreover, when non-polarized radiation is irradiated, irradiation needs to be performed from the direction inclined with respect to the coating film surface.

The light source of the radiation exposure can include, for instance, a low-pressure mercury lamp, a high-pressure mercury lamp, a deuterium lamp, a metal halide lamp, an argon resonance lamp, a xenon lamp, or an excimer laser. The ultraviolet in the preferred wavelength region can be obtained by, for instance, using the light sources with, for instance, a filter or a diffraction grating.

The radiation exposure is preferably equal to or greater than 1 J/m² and less than 10000 J/m², more preferably 10 J/m² to 3000 J/m². Moreover, when liquid crystal alignment capability is provided to a coating film formed by a conventionally known liquid crystal alignment agent through a photoalignment method, a radiation exposure equal to or greater than 10000 J/m² is needed. However, if the liquid crystal alignment agent of the invention is used, then even if the radiation exposure in the photoalignment method is equal to or less than 3000 J/m², further equal to or less than 1000 J/m², and further equal to or less than 300 J/m², good liquid crystal alignment capability can still be provided. As a result, production cost of the liquid crystal display element can be reduced.

### <Liquid Crystal Display Element and Preparation Method Thereof>

The liquid crystal display element of the invention includes the liquid crystal alignment film formed by the liquid crystal alignment agent of the invention. The liquid crystal display element of the invention can be manufactured according to the following method.

Two substrates on which a liquid crystal alignment film is formed are prepared, and liquid crystal is disposed between the two substrates to make a liquid crystal cell. To make the liquid crystal cell, the following two methods can be provided.

The first method includes first disposing the two substrates opposite to each other with a gap (cell gap) in between such that each liquid crystal alignment film is opposite to one another. Then, the peripheries of the two substrates are laminated together with a sealant. Next, liquid crystal is injected into the cell gap divided by the surfaces of the substrates and the sealant, and then the injection hole is sealed to obtain the liquid crystal cell.

The second method is called ODF (one drop fill, instillation). First, an ultraviolet curable sealing material for instance is coated on a predetermined portion on one of the two substrates forming the liquid crystal alignment films. Then, liquid crystal is dropped onto the liquid crystal alignment film, and then the other substrate is laminated such that the liquid crystal alignment films are opposite to each other. Next, ultraviolet is irradiated on the entire surface of the substrate such that the sealant is cured. The liquid crystal cell can thus be made.

When any one of the above methods is used, preferably, after the liquid crystal cell is next heated to the temperature at which the liquid crystals used are in an isotropic phase, the liquid crystal cell is slowly cooled to room temperature to remove the flow alignment when the liquid crystals are filled.

Next, by adhering a polarizer on the outer surface of the liquid crystal cell, the liquid crystal display element of the invention can be obtained. Here, when the liquid crystal alignment films have parallel alignment capability, a liquid crystal display element having a TN-type or STN-type liquid crystal cell can be obtained by adjusting the angle formed by the polarization direction of the linear polarized radiation irradiated in the two substrates on which a liquid crystal alignment film is formed and the angle of each substrate and the polarizer. Moreover, when the liquid crystal alignment films have vertical alignment capability, a liquid crystal display element having a vertical alignment-type liquid crystal cell can be obtained by constructing the liquid crystal cell so that the directions of easy-to-align axes of the two substrates on which a liquid crystal alignment film is formed are parallel; and by adhering a polarizer with the liquid crystal cell, the polarization direction thereof and the easy-to-align axes form a 45° angle.

The sealant includes, for instance, an epoxy resin containing an alumina ball used as a spacer and a curing agent.

Specific examples of the liquid crystal include, for instance, a nematic liquid crystal or a smectic liquid crystal.

When a TN-type or STN-type liquid crystal cell is used, the TN-type or STN-type liquid crystal cell preferably has a nematic liquid crystal having positive dielectric anisotropy, and examples thereof can include, for instance, a biphenyl-based liquid crystal, a phenyl cyclohexane-based liquid crystal, an ester-based liquid crystal, a terphenyl liquid crystal, a biphenyl cyclohexane-based liquid crystal, a pyrimidine-based liquid crystal, a dioxane-based liquid crystal, a bicyclooctane-based liquid crystal, or a cubane-based liquid crystal. Moreover, a cholesteric liquid crystal such as cholesteryl chloride, cholesteryl nonanoate, or cholesteryl carbonate . . . etc., a chiral agent sold under the product name of “C-15” or “CB-15” (made by Merck & Co.), or a ferroelectric liquid crystal such as p-decyloxybenzylidene-p-amino-2-methyl butyl cinnamate can further be added to the liquid crystal above.

Moreover, when a vertical alignment-type liquid crystal cell is used, the vertical alignment-type liquid crystal cell preferably has a nematic liquid crystal having negative dielectric anisotropy, and examples thereof can include, for instance, a dicyanobenzene-based liquid crystal, a pyridazine-based liquid crystal, a Schiff base-based liquid crystal, an azoxy-based liquid crystal, a biphenyl-based liquid crystal, or a phenyl cyclohexane-based liquid crystal.

The polarizer used on the outside of the liquid crystal cell can include, for instance, a polarizer formed by a polarizing film known as “H film” obtained by clamping polyvinyl alcohol which is stretched aligned and absorbs iodine with a cellulose acetate protective film, or a polarizer formed by the “H film” itself.

The liquid crystal display element of the invention thus made has excellent display performance, and even after prolonged use, the display performance is not worsened.

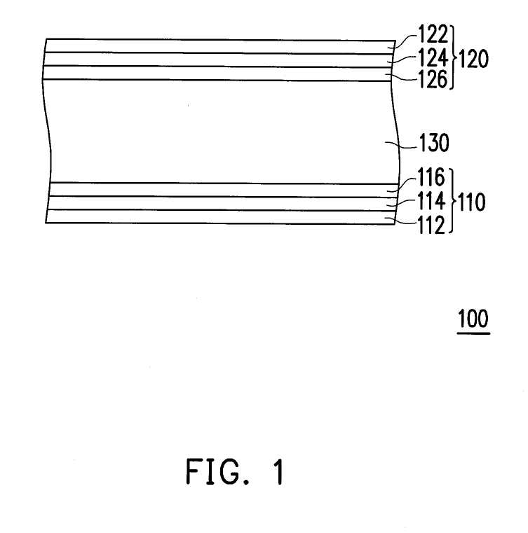

FIG. 1 is a side view of a liquid crystal display element according to an embodiment of the invention. A liquid crystal display element 100 includes a first unit 110, a second unit 120, and a liquid crystal unit 130, wherein the second unit 120 and the first unit 110 are separately disposed and the liquid crystal unit 130 is disposed between the first unit 110 and the second unit 120.

The first unit 110 includes a first substrate 112, a first conductive film 114, and a first liquid crystal alignment film 116, wherein the first conductive film 114 is located between the first substrate 112 and the first liquid crystal alignment film 116, and the first liquid crystal alignment film 116 is located on one side of the liquid crystal unit 130.

The second unit 120 includes a second substrate 122, a second conductive film 124, and a second liquid crystal alignment film 126, wherein the second conductive film 124 is located between the second substrate 122 and the second liquid crystal alignment film 126, and the second liquid crystal alignment film 126 is located on another side of the liquid crystal unit 130. In other words, the liquid crystal unit 130 is located between the first liquid crystal alignment film 116 and the second liquid crystal alignment film 126.

The first substrate 112 and the second substrate 122 are selected from, for instance, a transparent material, wherein the transparent material includes, but is not limited to, for instance, alkali-free glass, soda-lime glass, hard glass (Pyrex glass), quartz glass, polyethylene terephthalate, polybutylene terephthalate, polyethersulfone, or polycarbonate for a liquid crystal display apparatus. The material of each of the first conductive film 114 and the second conductive film 124 is selected from, for instance, tin oxide (SnO₂) or indium oxide-tin oxide (In₂O₃—SnO₂).

The first liquid crystal alignment film 116 and the second liquid crystal alignment film 126 are respectively the above liquid crystal alignment films, and the function thereof is to make the liquid crystal unit 130 form a pre-tilt angle. Moreover, when a voltage is applied to the first conductive film 114 and the second conductive film 124, an electric field can be generated between the first conductive film 114 and the second conductive film 124. The electric field can drive the liquid crystal unit 130, thereby causing change to the arrangement of the liquid crystal molecules in the liquid crystal unit 130.

The following examples are used to further describe the invention. However, it should be understood that, the examples are only exemplary, and are not intended to limit the implementation of the invention.

### Synthesis Examples of Polymer (A)

In the following, synthesis example A-1-1 to synthesis example A-1-3 of the polymer (A) are described:

### Synthesis Example A-1-1

A nitrogen inlet, a stirrer, a condenser, and a thermometer were provided in a 500 ml four-neck flask, and then nitrogen gas was introduced. Then, in a four-necked flask, 3.63 g (0.006 moles) of a diamine compound represented by formula (1-10) (hereinafter a2-1-1), 4.76 g (0.044 moles) of p-diaminobenzene (hereinafter a2-2-1), and 80 g of N-methyl-2-pyrrolidone (NMP) were added, and the components were stirred under room temperature until dissolved. Next, 10.91 g (0.05 moles) of pyromellitic dianhydride (hereinafter a1-1) and 20 g of NMP were added, and the mixture was reacted at room temperature for 2 hours. After the reaction was complete, the reaction solution was poured into 1500 ml of water to precipitate a polymer. Then, the obtained polymer was filtered and was repeatedly washed with methanol and filtered three times. The polymer was then placed in a vacuum oven and dried at a temperature of 60° C., thereby obtaining a polymer (A-1-1).

### Synthesis Example A-1-2 to Synthesis Example A-1-3

Polymer (A-1-2) to polymer (A-1-3) of synthesis example A-1-2 to synthesis example A-1-3 were respectively prepared with the same steps as synthesis example A-1-1, and the difference thereof is: the types and the usage amounts of the monomers were changed (as shown in Table 1).

### Synthesis Examples of Polymer

In the following, synthesis example A-2-1 to synthesis example A-2-10 of the polymer are described:

### Synthesis Example A-2-1

A nitrogen inlet, a stirrer, a condenser, and a thermometer were provided in a 500 ml four-neck flask, and then nitrogen gas was introduced. Then, in a four-necked flask, 3.63 g (0.006 moles) of a diamine compound represented by formula (1-10) (hereinafter a2-1-1), 4.76 g (0.044 moles) of p-diaminobenzene (hereinafter a2-2-1), and 80 g of N-methyl-2-pyrrolidone (NMP) were added, and the components were stirred under room temperature until dissolved. Next, 10.91 g (0.05 moles) of pyromellitic dianhydride (hereinafter a-1-1) and 20 g of NMP were added. After the mixture was reacted at room temperature for 6 hours, 97 g of NMP, 2.55 g of acetic anhydride, and 19.75 g of pyridine were added. Then, the temperature was raised to 60° C., and the mixture was continuously stirred for 2 hours to perform an imidization reaction. After the reaction was complete, the reaction solution was poured into 1500 ml of water to precipitate a polymer. Then, the obtained polymer was filtered and was repeatedly washed with methanol and filtered three times. The polymer was then placed in a vacuum oven and dried at a temperature of 60° C., thereby obtaining a polymer (A-2-1).

### Synthesis Example A-2-2 to Synthesis Example A-2-10

Polymer (A-2-2) to polymer (A-2-10) of synthesis example A-2-2 to synthesis example A-2-10 were respectively prepared with the same steps as synthesis example A-2-1, and the difference thereof is: the types and the usage amounts of the monomers were changed (as shown in Table 1).

### Comparative Synthesis Example A-3-1 to Comparative Synthesis Example A-3-4 of Polymer

Polymer (A-3-1) to polymer (A-3-4) of comparative synthesis example A-3-1 to comparative synthesis example A-3-4 were respectively prepared with the same steps as synthesis example A-1-1, and the difference thereof is: the types and the usage amounts of the monomers were changed (as shown in Table 2).

### Comparative Synthesis Example A-3-5 to Comparative Synthesis Example A-3-9 of Polymer

Polymer (A-3-5) to polymer (A-3-9) of comparative synthesis example A-3-5 to comparative synthesis example A-3-9 were respectively prepared with the same steps as synthesis example A-2-1, and the difference thereof is: the types and the usage amounts of the monomers, the catalysts, and the dehydrating agents were changed (as shown in Table 2).

The compounds corresponding to the abbreviations in Table 1 and Table 2 are as shown below.

| Abbreviation | Component |
|---|---|
| a1-1 | Pyromellitic dianhydride |
| a1-2 | 1,2,3,4-cyclobutane tetracarboxylic dianhydride |
| a1-3 | 2,3,5-tricarboxycyclopentylacetic acid dianhydride |
| a2-1-1 | 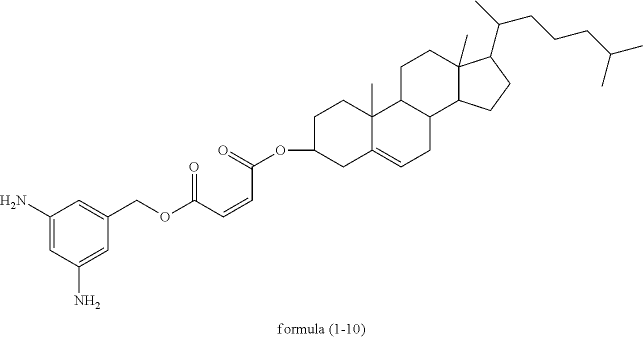 [SMILES: CC(C)CCCC(C)C1CCC2C3CC=C4CC(OC(=O)/C=C\C(=O)OCc5cc(N)cc(N)c5)CCC4(C)C3CCC12C] |
| a2-1-2 | 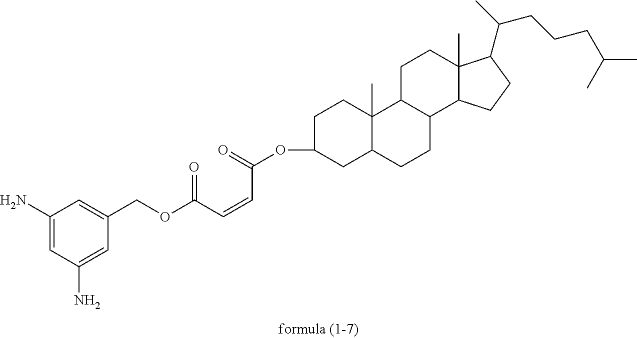 [SMILES: CC(C)CCCC(C)C1CCC2C3CCC4CC(OC(=O)/C=C\C(=O)OCc5cc(N)cc(N)c5)CCC4(C)C3CCC12C] |
| a2-1-3 | 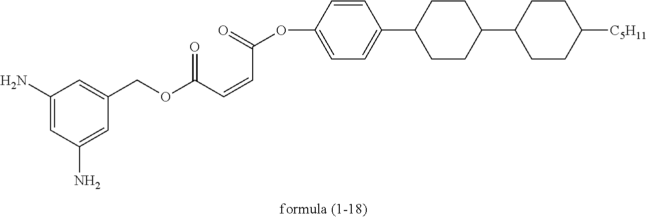 |
| a2-1-4 | 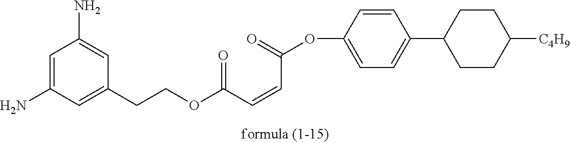 |
| a2-1-5 | 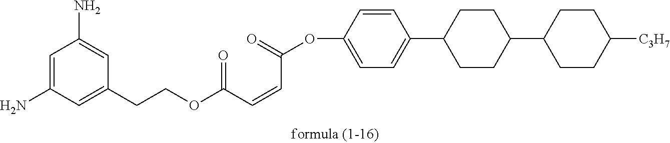 |
| a2-1-6 | 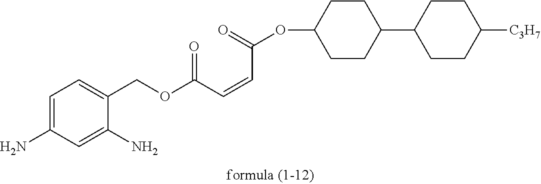 |
| a2-2-1 | p-diaminobezene |
| a2-2-2 | 4,4′-diaminodiphenylmethane |
| a2-2-3 | 4,4′-diaminodiphenyl ether |
| a2-2-4 | 3,3′-diamino-chalcone |
| a2-2-5 | 4,4′-diamino-stilbene |
| a2-2-6 | 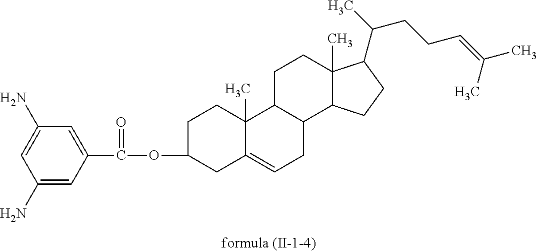 [SMILES: CC(C)=CCCC(C)C1CCC2C3CC=C4CC(OC(=O)c5cc(N)cc(N)c5)CCC4(C)C3CCC12C] |
| a2-2-7 | 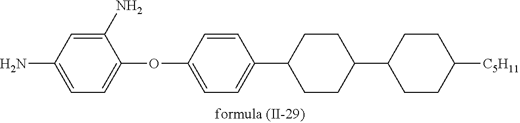 |
| a2-2-8 | 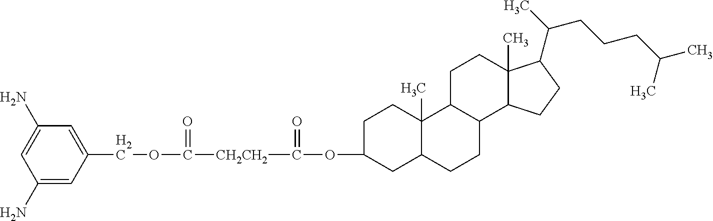 |

TABLE 1

| Component | | | Synthesis example | | | | | | | | | | | | |
|---|---|---|---|---|---|---|---|---|---|---|---|---|---|---|---|
| (unit: mole %) | | | A-1-1 | A-1-2 | A-1-3 | A-2-1 | A-2-2 | A-2-3 | A-2-4 | A-2-5 | A-2-6 | A-2-7 | A-2-8 | A-2-9 | A-2-10 |
| Tetracarboxylic | | a1-1 | 100 | — | — | 100 | — | — | — | 50 | — | — | 100 | 60 | — |
| dianhydride component | | a1-2 | — | 100 | — | — | 100 | — | 100 | 50 | — | 90 | — | 40 | 100 |
| (a1) | | a1-3 | — | — | 100 | — | — | 100 | — | — | 105 | 10 | — | — | — |
| Diamine | Diamine | a2-1-1 | 12 | — | — | 12 | — | — | 3 | — | — | — | 10 | — | — |
| component | compound | a2-1-2 | — | 5 | — | — | 5 | — | — | 0.5 | — | — | — | 1 | — |
| (a2) | (a2-1) | a2-1-3 | — | — | 10 | — | — | 10 | — | — | 5 | — | — | — | 18 |
| | | a2-1-4 | — | — | 10 | — | — | 10 | — | — | — | 1 | — | — | — |
| | | a2-1-5 | — | — | — | — | — | — | — | — | 10 | — | — | — | — |
| | | a2-1-6 | — | — | — | — | — | — | — | — | — | — | — | 1 | — |
| | Diamine | a2-2-1 | 88 | — | — | 88 | — | — | — | 90 | — | — | — | 95 | — |
| | compound | a2-2-2 | — | 90 | — | — | 90 | — | 90 | — | 85 | — | 70 | — | — |
| | (a2-2) | a2-2-3 | — | — | 80 | — | — | 80 | — | 10 | — | 95 | — | — | 70 |
| | | a2-2-4 | — | — | — | — | — | — | — | — | — | — | 20 | — | — |
| | | a2-2-5 | — | — | — | — | — | — | — | — | — | — | — | — | 12 |
| | | a2-2-6 | — | 5 | — | — | 5 | — | — | — | — | 4 | — | — | — |
| | | a2-2-7 | — | — | — | — | — | — | 7 | — | — | — | — | 3 | — |
| | | a2-2-8 | — | — | — | — | — | — | — | — | — | — | — | — | — |

| | | | | | | | | | | | | | |
|---|---|---|---|---|---|---|---|---|---|---|---|---|---|
| Imidization ratio (%) | 0 | 0 | 0 | 15 | 26 | 30 | 43 | 52 | 68 | 73 | 84 | 90 | 95 |

TABLE 2

| Component | | | Comparative synthesis example | | | | | | | | |
|---|---|---|---|---|---|---|---|---|---|---|---|
| (unit: mole %) | | | A-3-1 | A-3-2 | A-3-3 | A-3-4 | A-3-5 | A-3-6 | A-3-7 | A-3-8 | A-3-9 |
| Tetracarboxylic | | a1-1 | 100 | — | 100 | — | — | — | 100 | — | 100 |
| dianhydride component | | a1-2 | — | 100 | — | 100 | — | 100 | — | 100 | — |
| (a1) | | a1-3 | — | — | — | — | 100 | — | — | — | — |
| Diamine | Diamine | a2-1-1 | — | — | — | — | — | — | — | — | — |
| component | compound | a2-1-2 | — | — | — | — | — | — | — | — | — |
| (a2) | (a2-1) | a2-1-3 | — | — | — | — | — | — | — | — | — |
| | | a2-1-4 | — | — | — | — | — | — | — | — | — |
| | | a2-1-5 | — | — | — | — | — | — | — | — | — |
| | | a2-1-6 | — | — | — | — | — | — | — | — | — |
| | Diamine | a2-2-1 | 88 | — | 70 | — | 20 | 3 | 70 | — | — |
| | compound | a2-2-2 | 12 | 95 | — | 80 | — | 90 | — | 80 | 70 |
| | (a2-2) | a2-2-3 | — | — | — | — | 80 | — | — | — | — |
| | | a2-2-4 | — | — | 30 | — | — | — | 30 | — | 20 |
| | | a2-2-5 | — | — | — | 20 | — | — | — | 20 | — |
| | | a2-2-6 | — | 5 | — | — | — | — | — | — | — |
| | | a2-2-7 | — | — | — | — | — | 7 | — | — | — |
| | | a2-2-8 | — | — | — | — | — | — | — | — | 10 |

| | | | | | | | | | |
|---|---|---|---|---|---|---|---|---|---|
| Imidization ratio (%) | 0 | 0 | 0 | 0 | 30 | 43 | 15 | 26 | 84 |

### Synthesis Examples of Photosensitive Polysiloxane (B)

### Preparation Examples of the Cinnamic Acid Derivative (b2)

Preparation examples b2-1 to b2-5 of the cinnamic acid derivative (b2) are described below:

### Preparation Example b2-1

Preparation example b2-1 includes a cinnamic acid derivative (b2-1) synthesized according to the following reaction scheme.

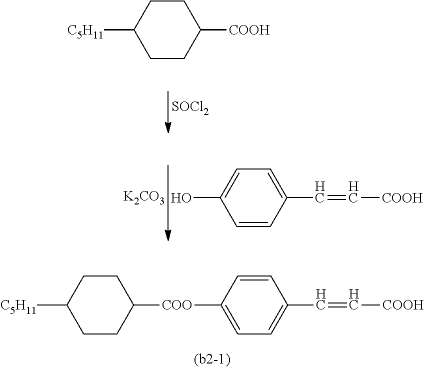

In detail, 9.91 g of 4-pentyl-transcyclohexylcarboxylic acid, 100 mL of thionyl chloride, and 77 μL of N,N-dimethylformamide were added in a 500 mL three-necked flask in order, and the components were stirred at 80° C. for 1 hour. Then, after thionyl chloride was removed via distillation under reduced pressure, dichloromethane was added. Then, washing was performed with an aqueous solution of sodium bicarbonate, and then drying was performed with magnesium sulfate. After concentration was performed, tetrahydrofuran was added to form a solution (b2-a).

Further, 7.39 g of 4-hydroxycinnamic acid, 13.82 g of potassium carbonate, 0.48 g of tetrabutylammonium, 50 mL of tetrahydrofuran, and 100 mL of water were added in another 500 mL three-necked flask. After the aqueous solution was cooled with ice, the solution (b2-a) obtained above was slowly added dropwise, and the mixture was stirred and reacted for 2 hours. After the reaction was complete, hydrochloric acid was added to neutralize the reaction mixture, and then extraction was performed with ethyl acetate. After the organic layer was washed with water, the organic layer was dried with magnesium sulfate, and after concentration was performed, recrystallization was performed using ethanol to obtain 13 g of the cinnamic acid derivative (b2-1).

### Preparation Example b2-2

Preparation example b2-2 includes a cinnamic acid derivative (b2-2) synthesized according to the following reaction scheme.

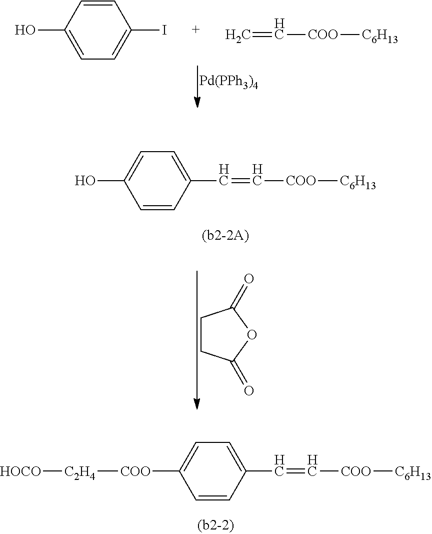

In a 2 L three-necked flask provided with a thermometer and a nitrogen inlet tube, 22 g of 4-iodophenol, 16 g of hexyl acrylate, 14 mL of triethylamine, 2.3 g of tetrakis(triphenylphosphine)palladium, and 1 L of N,N-dimethylformamide were added, and nitrogen was introduced to sufficiently dry the interior of the flask. Then, the mixture was heated to 90° C. and reacted by stirring under a stream of nitrogen for 2 hours. After the reaction was complete, diluted hydrochloric acid was added to neutralize the reaction mixture, and then extraction was performed with ethyl acetate. After the organic layer was washed with water, the organic layer was dried with magnesium sulfate, and after concentration was performed, recrystallization was performed using ethanol to obtain 12 g of the compound (b2-2A).

Next, 12 g of the compound (b2-2A), 5.5 g of succinic anhydride, and 0.6 g of 4-dimethylaminopyridine were added in a 200 mL three-necked flask provided with a thermometer, a nitrogen inlet tube, and a reflux tube, and then nitrogen was introduced to sufficiently dry the interior of the flask. Then, 5.6 g of triethylamine and 100 mL of tetrahydrofuran were added in the mixture, and then the mixture was reacted under reflux for 5 hours. After the reaction was complete, diluted hydrochloric acid was added to neutralize the reaction mixture, and then extraction was performed with ethyl acetate. After the organic layer was washed with water, the organic layer was dried with magnesium sulfate, and after concentration was performed, recrystallization was performed using ethanol to obtain 8.7 g of the cinnamic acid derivative (b2-2).

### Preparation Example b2-3

Preparation example b2-3 includes a cinnamic acid derivative (b2-3) synthesized according to the following reaction scheme.

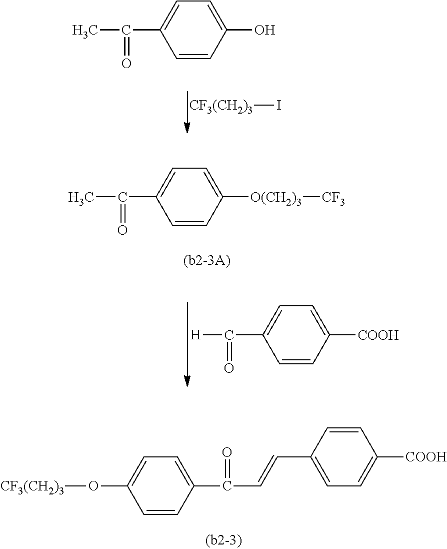

In detail, 27.2 g of 4-hydroxyacetophenone, 27.6 g of potassium carbonate, 1.0 g of potassium iodide, and 500 mL of acetone were added in a 1 L three-necked flask, and after the components were stirred under room temperature for 30 minutes, 47.6 g of 1-iodo-4,4,4-trifluorobutane was added, and then the mixture was reacted by refluxing in a nitrogen atmosphere for 5 hours. After the reaction was complete, the reaction solution was poured into water to precipitate a product. The resulting precipitate was filtered, and then recrystallization was performed using acetone to obtain 33 g of the compound (b2-3A).

Further, 23.2 g of the compound (b2-3A) obtained above, 15.0 g of 4-formyl benzoic acid, 8.0 g of sodium hydroxide, and 150 mL of ethanol were added in a 500 mL three-necked flask, and the components were reacted under reflux for 6 hours. After the reaction was complete, the mixture was cooled to room temperature, then 200 mL of water was added, and then the mixture was stirred until uniform. The solution was added to a 1 L beaker, and concentrated hydrochloric acid was added dropwise while stirring until the pH value of the solution was 7 or less. The precipitate formed in the beaker was filtered, and recrystallization was performed using ethanol to obtain 35 g of the cinnamic acid derivative (b2-3).

### Preparation Example b2-4

Preparation example b2-4 includes a cinnamic acid derivative (b2-4) synthesized according to the following reaction scheme.

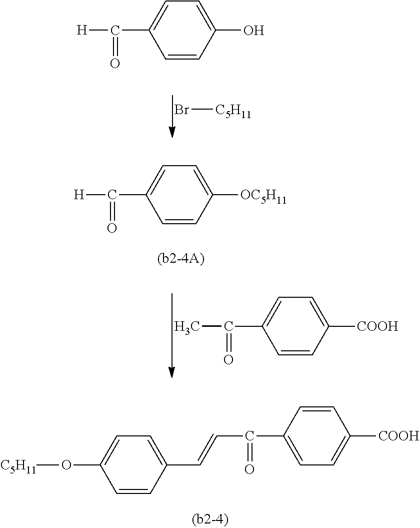

In detail, 24.4 g of 4-hydroxybenzaldehyde, 27.6 g of potassium carbonate, 1.0 g of potassium iodide, and 500 mL of acetone were added in a 1 L three-necked flask. After the components were stirred under room temperature for 30 minutes, 30.2 g of 1-bromopentane was added, and then the mixture was reacted by refluxing in a nitrogen atmosphere for 5 hours. After the reaction was complete, the reaction solution was poured into water to precipitate a product. The resulting precipitate was filtered, and then recrystallization was performed using acetone to obtain the compound (b2-4A).

Further, 19.2 g of the compound (b2-4A) obtained above, 16.4 g of 4-acetyl benzoic acid, 8.0 g of sodium hydroxide, and 150 mL of ethanol were added in a 500 mL three-necked flask, and the components were reacted under reflux for 6 hours. After the reaction was complete, the mixture was cooled to room temperature, then 200 mL of water was added, and then the mixture was stirred until uniform. The solution was added to a 1 L beaker, and concentrated hydrochloric acid was added dropwise while stirring until the pH value of the solution was 7 or less. The precipitate formed in the beaker was filtered, and recrystallization was performed using ethanol to obtain 29 g of the cinnamic acid derivative (b2-4).

### Preparation Example b2-5

Preparation example b2-5 includes a cinnamic acid derivative (b2-5) synthesized according to the following reaction scheme.

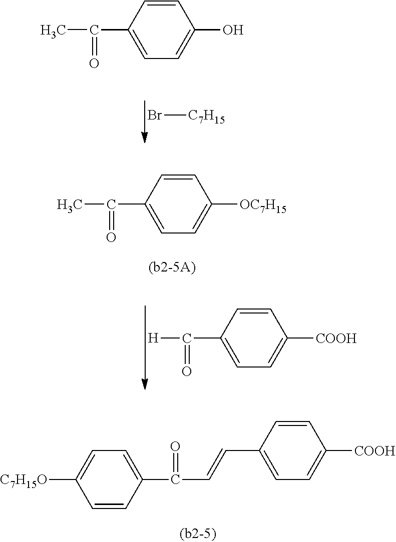

In detail, 27.2 g of 4-hydroxyacetophenone, 27.6 g of potassium carbonate, 1.0 g of potassium iodide, and 500 mL of acetone were added in a 1 L three-necked flask. After the components were stirred under room temperature for 30 minutes, 35.8 g of 1-bromoheptane was added, and then the mixture was reacted by refluxing in a nitrogen atmosphere for 5 hours. After the reaction was complete, the reaction solution was poured into water to precipitate a product. The resulting precipitate was filtered, and then recrystallization was performed using acetone to obtain 41 g of a compound (b2-5A).

Further, 23.4 g of the compound (b2-5A) obtained above, 15.0 g of 4-formyl benzoic acid, 8.0 g of sodium hydroxide, and 150 mL of ethanol were added in a 500 mL three-necked flask, and the components were reacted under reflux for 6 hours. After the reaction was complete, the mixture was cooled to room temperature, then 200 mL of water was added, and then the mixture was stirred until uniform. The solution was added to a 1 L beaker, and concentrated hydrochloric acid was added dropwise while stirring until the pH value of the solution was 7 or less. The precipitate formed in the beaker was filtered, and recrystallization was performed using ethanol to obtain 28 g of the cinnamic acid derivative (b2-5).

Synthesis example B-1 to synthesis example B-6 of the photosensitive polysiloxane (B) are described below:

### Synthesis Example B-1

A stirrer, a condenser tube, and a thermometer were provided to a three-necked flask having a volume of 500 mL. Then, in a three-necked flask, 0.50 moles of 2-glycidoxyethyltrimethoxy silane (hereinafter GETMS), 0.4 moles of methyltrimethoxy silane (hereinafter MTMS), 0.10 moles of dimethyldimethoxy silane (hereinafter DMDMS), and 6 g of propyleneglycolmonomethylether (hereinafter PGME) were added, and the mixture was stirred under room temperature while an aqueous solution of triethylamine (hereinafter TEA) (20 g of TEA/200 g of H₂O) was added within 30 minutes. Then, the three-necked flask was immersed in an oil bath at 30 t and stirred for 30 minutes, and then the temperature of the oil bath was raised to 90 t within 30 minutes. When the internal temperature of the solution reached 75° C., the mixture was continuously heated and stirred to perform polycondensation for 6 hours. After the reaction was complete, the organic layer was removed and washed with an aqueous solution of 0.2 wt % ammonium nitrate to obtain a solution containing a polysiloxane compound.

Then, 0.45 moles of the cinnamic acid derivative obtained in preparation example b2-1 (hereinafter 5HBPA) and 0.2 g of a curing promoter UCAT 18X (made by SAN-APRO) were added to the solution containing a polysiloxane compound. Then, the three-necked flask was immersed in an oil bath at 30° C. and stirred for 10 minutes, and then the temperature of the oil bath was raised to 115° C. within 30 minutes. When the internal temperature of the solution reached 100° C., the mixture was continuously heated and stirred for 24 hours. After the reaction was complete, the organic layer was removed and washed with water. Then, drying was performed by using magnesium sulfate, and after the solvent was removed, polysiloxane (B-1) was obtained.

### Synthesis Example B-2 to Synthesis Example B-6

Polysiloxane (B-2) to polysiloxane (B-6) of synthesis example B-2 to synthesis example B-6 were prepared with the same steps as synthesis example B-1, and the difference thereof is: the types and the usage amounts of the reactants of the polysiloxane (B) were changed, the type and the usage amount of the cinnamic acid derivatives were changed, the types and the usage amounts of the catalysts and the solvents were changed, and the reaction temperatures and the polycondensation times were changed (as shown in Table 3).

### Synthesis Example B′-1 to Synthesis Example B′-3

Polysiloxane (B′-1) to polysiloxane (B′-3) of synthesis example B′-1 to synthesis example B′-3 were prepared with the same steps as synthesis example B-1, and the difference thereof is: the types and the usage amounts of the reactants of the polysiloxane (B) were changed, the types and the usage amounts of the carboxylic acid compounds were changed, the types and the usage amounts of the catalysts and the solvents were changed, and the reaction temperatures and the polycondensation times were changed (as shown in Table 3).

The compounds corresponding to the abbreviations in Table 3 are as shown below.

| Abbreviation | Component |
|---|---|
| GETMS | 2-glycidoxyethyltrimethoxy silane |
| GBTMS | 4-glycidoxybutyltrimethoxysilane |
| ECETS | 2-(3,4-epoxycyclohexyl)ethyltrimethoxy silane |
| ECEES | 2-(3,4-epoxycyclohexyl)ethyltriethoxysilane |
| OXTMS | (3-ethyl-3-oxetanyl)methoxy)propyltrimethoxysilane |
| OXTES | (3-ethyl-3-oxetanyl)methoxy)propyltriethoxysilane |
| MTMS | Methyltrimethoxy silane |
| DMDMS | Dimethyldimethoxy silane |
| PTMS | Phenyltrimethoxy silane |
| PTES | Phenyltriethoxy silane |
| 5HBPA | 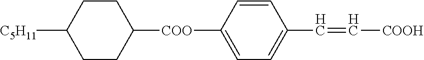 |
| | Compound of preparation example b2-1 |
| 6PB2A | 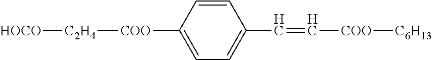 |
| | Compound of preparation example b2-2 |
| FBPAA | 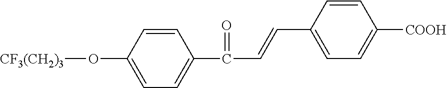 |
| | Compound of preparation example b2-3 |
| 5BPAA | 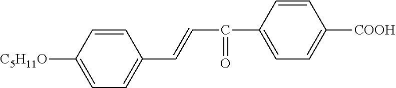 |
| | Compound of preparation example b2-4 |
| 7BPBA | 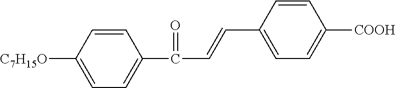 |
| | Compound of preparation example b2-5 |
| PGME | Propyleneglycolmonomethylether |
| MIBK | Methylisobutylketone |
| H₂O | Water |
| TEA | Triethylamine |

TABLE 3

| Component | | Synthesis example | | | | | | | | |
|---|---|---|---|---|---|---|---|---|---|---|
| (unit: mole) | | B-1 | B-2 | B-3 | B-4 | B-5 | B-6 | B′-1 | B′-2 | B′-3 |
| Silane | GETMS | 0.50 | — | — | 0.80 | — | — | 0.5 | — | — |
| compound | GBTMS | — | — | 0.20 | — | — | — | — | — | — |
| (b1-1) | ECETS | — | — | 0.30 | — | — | — | — | — | — |
| containing | ECEES | — | 0.20 | — | — | 1.00 | — | — | — | — |
| an epoxy | OXTMS | — | 0.10 | — | — | — | — | — | — | — |
| group | OXTES | — | — | — | — | — | 0.60 | — | — | — |
| Other | MTMS | 0.40 | — | — | — | — | 0.10 | 0.40 | 0.30 | 0.50 |
| Silane | DMDS | 0.10 | — | 0.50 | 0.10 | — | — | 0.10 | — | 0.50 |
| compounds | PTMS | — | 0.70 | — | — | — | — | — | 0.70 | — |
| (b1-2) | PTES | — | — | — | 0.10 | — | 0.30 | — | — | — |
| Cinnamic | 5HBPA | 0.45 | — | — | 0.02 | — | — | — | — | — |
| acid | 6PB2A | — | 0.10 | — | — | 0.20 | — | — | 0.10 | — |
| derivative | FBPAA | — | — | 0.05 | — | 0.50 | — | — | — | — |
| (b2) | 5BPBA | — | — | — | 0.05 | — | — | — | — | — |
| | 7BPBA | — | — | — | — | — | 0.50 | — | — | — |
| Molar equivalent of | | 0.9 | 0.3 | 0.1 | 0.08 | 0.7 | 0.8 | — | — | — |
| (b2)/(b1-1) | | | | | | | | | | |
| Solvent | PGME | 6 | — | — | 6 | 8 | 9 | 6 | — | — |
| (g) | MIBK | — | 6 | 8 | 2 | — | — | — | 6 | 8 |
| Catalyst | H₂O | 200 | 200 | 250 | 250 | 200 | 230 | 200 | 200 | 250 |
| (g) | TEA | 20 | 20 | 22 | 25 | 20 | 20 | 20 | 20 | 22 |

| | | | | | | | | | |
|---|---|---|---|---|---|---|---|---|---|
| Reaction temperature | 75 | 70 | 80 | 85 | 70 | 65 | 75 | 70 | 80 |
| (° C.) | | | | | | | | | |
| Polycondensation time | 6 | 6.5 | 6 | 5 | 7 | 8 | 6 | 6.5 | 6 |
| (hours) | | | | | | | | | |

### Examples and Comparative Examples of Liquid Crystal Alignment Agent, Liquid Crystal Alignment Film, and Liquid Crystal Display Element

Example 1 to example 15 and comparative example 1 to comparative example 16 of the liquid crystal alignment agent, the liquid crystal alignment film, and the liquid crystal display element are described below:

a. Liquid Crystal Alignment Agent

100 parts by weight of the polymer (A-1-1), 5 part by weight of the photosensitive polysiloxane (B-1), 1200 parts by weight of N-methyl-2-pyrrolidone (C-1 hereinafter), and 600 parts by weight of ethylene glycol n-butyl ether (C-2 hereinafter) were weighed. Then, the components were continuously stirred at room temperature with a stirring apparatus until dissolved, thereby forming the liquid crystal alignment agent of example 1.

b. Liquid Crystal Alignment Film and Liquid Crystal Display Element

The liquid crystal alignment agent was coated on a glass substrate having a layer of conductive film formed by ITO with a spin coating method. Then, pre-bake was performed on a heating plate at a temperature of 70° C. for 3 minutes, and post-bake was performed in a circulation oven at a temperature 220° C. for 20 minutes, thereby obtaining a coating film.

A Hg—Xe lamp and a Glan-Taylor prism were used to irradiate the surface of the coating film with polarized ultraviolet containing a 313 nm bright line for 50 seconds from a direction inclined 40° from the normal of the substrate, thereby providing liquid crystal alignment capability. A liquid crystal alignment film was thus fabricated. Here, the illumination of the irradiated surface under a wavelength of 313 nm was 2 mW/cm². The same operation was performed to fabricate 2 (1 pair) substrates having a liquid crystal alignment film.

Next, an epoxy resin sealant containing an alumina ball having a diameter of 5.5 μm was coated on the periphery of the surface of the pair of substrates on which a liquid crystal alignment film was formed with screen printing, and then the substrates were laminated in a manner that the liquid crystal alignment film of each substrate was opposite to each other, and the irradiation direction of the polarized ultraviolet was antiparallel, and then a pressure of 10 kg was applied with a hot press to perform hot press lamination at 150° C.

Next, liquid crystal was injected from the liquid crystal injection hole, and an epoxy resin-based sealant was used to seal the liquid crystal injection hole. To remove the flow alignment when liquid crystal is injected, the liquid crystal was heated to 150° C. and then slowly cooled to room temperature. Lastly, the polarizers were laminated on two sides on the outside of the substrate in a manner that the polarization directions of the polarizers were perpendicular to each other and form 45° with the polarization direction of the ultraviolet of the liquid crystal alignment film, thereby obtaining the liquid crystal display element of example 1. The liquid crystal display element of example 1 was evaluated by each of the following evaluation methods, and the results thereof are as shown in Table 4.

### Example 2 to Example 15

The liquid crystal alignment agents, the liquid crystal alignment films, and the liquid crystal display elements of example 2 to example 15 were respectively prepared by the same steps as example 1, and the difference thereof is: the types and the usage amounts of the components were changed, as shown in Table 4. The liquid crystal display element of each of examples 2 to 15 was evaluated with the evaluation methods below, and the results thereof are as shown in Table 4.

### Comparative Example 1 to Comparative Example 16

The liquid crystal alignment agents, the liquid crystal alignment films, and the liquid crystal display elements of comparative example 1 to comparative example 16 were respectively prepared by the same steps as example 1, and the difference is: the types and the usage amounts of the components were changed, as shown in Table 5. The liquid crystal display element obtained in each of comparative example 1 to comparative example 16 was evaluated with the evaluation methods below, and the results thereof are as shown in Table 5.

The compounds corresponding to the abbreviations in Table 4 and Table 5 are as shown below.

| Abbreviation | Component |
|---|---|
| A-1-1 | Polymer (A-1-1) |
| A-1-2 | Polymer (A-1-2) |
| A-1-3 | Polymer (A-1-3) |
| A-2-1 | Polymer (A-2-1) |
| A-2-2 | Polymer (A-2-2) |
| A-2-3 | Polymer (A-2-3) |
| A-2-4 | Polymer (A-2-4) |
| A-2-5 | Polymer (A-2-5) |
| A-2-6 | Polymer (A-2-6) |
| A-2-7 | Polymer (A-2-7) |
| A-2-8 | Polymer (A-2-8) |
| A-2-9 | Polymer (A-2-9) |
| A-2-10 | Polymer (A-2-10) |
| A-3-1 | Polymer (A-3-1) |
| A-3-2 | Polymer (A-3-2) |
| A-3-3 | Polymer (A-3-3) |
| A-3-4 | Polymer (A-3-4) |
| A-3-5 | Polymer (A-3-5) |
| A-3-6 | Polymer (A-3-6) |
| A-3-7 | Polymer (A-3-7) |
| A-3-8 | Polymer (A-3-8) |
| A-3-9 | Polymer (A-3-9) |
| B-1 | Photosensitive polysiloxane (B-1) |
| B-2 | Photosensitive polysiloxane (B-2) |
| B-3 | Photosensitive polysiloxane (B-3) |
| B-4 | Photosensitive polysiloxane (B-4) |
| B-5 | Photosensitive polysiloxane (B-5) |
| B-6 | Photosensitive polysiloxane (B-6) |
| B′-1 | Other polysiloxanes (B′-1) |
| B′-2 | Other polysiloxanes (B′-2) |
| B′-3 | Other polysiloxanes (B′-3) |
| C-1 | N-methyl-2-pyrrolidone (NMP) |
| C-2 | Ethylene glycol n-butyl ether |
| C-3 | N,N-dimethylacetamide |
| D-1 | N,N,N′,N′-tetraglycidyl-4,4′-diaminodiphenylmethane |
| D-2 | 3-aminopropyltriethoxysilane |

### Evaluation Methods

a. Imidization Ratio

The imidization ratio refers to the proportion of the number of imide rings based on the total amount of the number of amic acid functional groups and the number of imide rings in the polymer, and is represented in percentage.

The detection method includes dissolving the polymers of the synthesis examples in a suitable deuteration solvent (for instance, deuterated dimethyl sulfoxide) after respectively performing drying under reduced pressure. Then, a result of ¹H-nuclear magnetic resonance (¹H-NMR) was detected under room temperature (such as 25° C.) by using tetramethylsilane as reference material. The imidization ratio (%) was obtained by equation (1).

$$Imidization ratio ( \% ) = 1 - \frac{Δ 1}{Δ2 \times α} \times 100 \% \qquad equation ( 1 )$$

Δ1: peak area generated due to chemical shift of an NH group proton near 10 ppm;

Δ2: peak area of other protons;

α: number ratio of one proton of NH group relative to other protons in precursor (polyamic acid) of polymer.

b. Pre-Tilt Angle Light Stability

A liquid crystal evaluation apparatus (made by Central Motor Wheel, model OMS-CM4RD) was used to measure the pre-tilt angle of the liquid crystal display elements of examples 1 to 15 and comparative examples 1 to 15 through a crystal rotation method of He—Ne laser light according to a method recited in “T. J. Scheffer, et. al., J. Appl. Phys., vol. 19, 2013 (1980)”. The points of measurement include a total of 9 points at the center of 9 squares as shown in the following FIGURE. Pre-tilt angles P1 to P9 were respectively measured and obtained, and a pre-tilt angle light stability LS was calculated through the following equation:

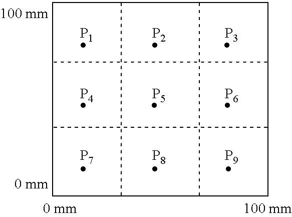

$$Dx = 90 - Px ( x = 1 \sim 9 )$$

$$\overline{Dx} = \frac{1}{9} ( {D}_{1} + {D}_{2} + {D}_{3} + {D}_{4} + {D}_{5} + {D}_{6} + {D}_{7} + {D}_{8} + {D}_{9} )$$

$$LS = \sqrt{\frac{\sum {( Dx - \overline{Dx} )}^{2}}{8}}$$

The evaluation criteria of pre-tilt angle light stability are as shown below.

### ⊚: LS<0.1

### ◯: 0.1≦LS<0.15

### Δ: 0.15≦LS<0.2

### X: LS≧0.2

TABLE 4

| Component | | Example | | | | | | | |
|---|---|---|---|---|---|---|---|---|---|
| (unit: parts by weight) | | 1 | 2 | 3 | 4 | 5 | 6 | 7 | 8 |
| Polymer (A) | A-1-1 | 100 | — | — | — | — | — | — | — |
| | A-1-2 | — | 100 | — | — | — | — | — | — |
| | A-1-3 | — | — | 100 | — | — | — | — | — |
| | A-2-1 | — | — | — | 100 | — | — | — | — |
| | A-2-2 | — | — | — | — | 100 | — | — | — |
| | A-2-3 | — | — | — | — | — | 100 | — | — |
| | A-2-4 | — | — | — | — | — | — | 100 | — |
| | A-2-5 | — | — | — | — | — | — | — | 100 |
| | A-2-6 | — | — | — | — | — | — | — | — |
| | A-2-7 | — | — | — | — | — | — | — | — |
| | A-2-8 | — | — | — | — | — | — | — | — |
| | A-2-9 | — | — | — | — | — | — | — | — |
| | A-2-10 | — | — | — | — | — | — | — | — |
| | A-3-1 | — | — | — | — | — | — | — | — |
| | A-3-2 | — | — | — | — | — | — | — | — |
| | A-3-3 | — | — | — | — | — | — | — | — |
| | A-3-4 | — | — | — | — | — | — | — | — |
| | A-3-5 | — | — | — | — | — | — | — | — |
| | A-3-6 | — | — | — | — | — | — | — | — |
| | A-3-7 | — | — | — | — | — | — | — | — |
| | A-3-8 | — | — | — | — | — | — | — | — |
| | A-3-9 | — | — | — | — | — | — | — | — |
| Photosensitive | B-1 | 5 | — | — | — | — | — | — | — |
| polysiloxane | B-2 | — | 10 | — | — | — | — | — | 2 |
| (B) | B-3 | — | — | 12 | — | — | — | — | 2 |
| | B-4 | — | — | — | 20 | — | — | 8 | — |
| | B-5 | — | — | — | — | 3 | — | — | — |
| | B-6 | — | — | — | — | — | 25 | — | — |
| Other | B′-1 | — | — | — | — | — | — | — | — |
| polysiloxanes | B′-2 | — | — | — | — | — | — | — | — |
| (B′) | B′-3 | — | — | — | — | — | — | — | — |
| Solvent (C) | C-1 | 1200 | — | 800 | 700 | — | 1000 | 900 | 850 |
| | C-2 | 600 | 1600 | — | 700 | 1200 | — | 900 | 850 |
| | C-3 | — | — | 1000 | — | 100 | — | 300 | — |
| Additive (D) | D-1 | — | — | 2 | — | — | — | — | — |
| | D-2 | — | — | — | — | — | — | 1 | — |
| Evaluation | Pre-tilt | ◯ | ⊚ | ⊚ | ⊚ | ⊚ | ⊚ | ⊚ | ⊚ |
| Items | angle | | | | | | | | |
| | Light | | | | | | | | |
| | stability | | | | | | | | |

| Component | | Example | | | | | | |
|---|---|---|---|---|---|---|---|---|
| (unit: parts by weight) | | 9 | 10 | 11 | 12 | 13 | 14 | 15 |
| Polymer (A) | A-1-1 | — | — | 40 | — | — | — | — |
| | A-1-2 | — | — | — | — | 95 | — | — |
| | A-1-3 | — | — | — | — | — | — | 10 |
| | A-2-1 | — | — | — | — | — | — | 90 |
| | A-2-2 | — | — | — | — | — | — | — |
| | A-2-3 | — | — | — | — | — | — | — |
| | A-2-4 | — | — | — | — | — | — | — |
| | A-2-5 | — | — | — | — | — | 50 | — |
| | A-2-6 | 100 | — | — | — | — | 50 | — |
| | A-2-7 | — | 100 | — | — | — | — | — |
| | A-2-8 | — | — | 60 | — | — | — | — |
| | A-2-9 | — | — | — | 100 | — | — | — |
| | A-2-10 | — | — | — | — | 5 | — | — |
| | A-3-1 | — | — | — | — | — | — | — |
| | A-3-2 | — | — | — | — | — | — | — |
| | A-3-3 | — | — | — | — | — | — | — |
| | A-3-4 | — | — | — | — | — | — | — |
| | A-3-5 | — | — | — | — | — | — | — |
| | A-3-6 | — | — | — | — | — | — | — |
| | A-3-7 | — | — | — | — | — | — | — |
| | A-3-8 | — | — | — | — | — | — | — |
| | A-3-9 | — | — | — | — | — | — | — |
| Photosensitive | B-1 | — | 15 | — | — | — | — | — |
| polysiloxane | B-2 | — | — | — | — | — | — | — |
| (B) | B-3 | — | — | 10 | — | — | 6 | — |
| | B-4 | — | — | — | — | 18 | — | 5 |
| | B-5 | 6 | — | 20 | — | — | 4 | — |
| | B-6 | — | — | — | 10 | — | — | — |
| Other | B′-1 | — | — | — | — | — | — | — |
| polysiloxanes | B′-2 | — | — | — | — | — | — | — |
| (B′) | B′-3 | — | — | — | — | — | — | — |
| Solvent (C) | C-1 | 2000 | — | — | — | 450 | 700 | — |
| | C-2 | — | 950 | 1600 | 800 | 1800 | — | 1000 |
| | C-3 | — | — | 900 | 1500 | 1800 | 900 | 1500 |
| Additive (D) | D-1 | — | 3 | — | — | — | — | — |
| | D-2 | — | 2 | — | — | — | — | — |
| Evaluation | Pre-tilt | ⊚ | ⊚ | ⊚ | ⊚ | ⊚ | ⊚ | ⊚ |
| Items | angle | | | | | | | |
| | Light | | | | | | | |
| | stability | | | | | | | |

TABLE 5

| Component | | Comparative example | | | | | | | |
|---|---|---|---|---|---|---|---|---|---|
| (unit: parts by weight) | | 1 | 2 | 3 | 4 | 5 | 6 | 7 | 8 |
| Polymer (A) | A-1-1 | — | — | — | — | — | — | — | — |
| | A-1-2 | — | — | — | — | — | — | — | — |
| | A-1-3 | — | — | — | — | — | — | — | — |
| | A-2-1 | — | — | — | — | — | — | — | — |
| | A-2-2 | — | — | — | — | — | — | — | — |
| | A-2-3 | — | — | — | — | — | — | — | — |
| | A-2-4 | — | — | — | — | — | — | — | — |
| | A-2-5 | — | — | — | — | — | — | — | — |
| | A-2-6 | — | — | — | — | — | — | — | — |
| | A-2-7 | — | — | — | — | — | — | — | — |
| | A-2-8 | — | — | — | — | — | — | — | — |
| | A-2-9 | — | — | — | — | — | — | — | — |
| | A-2-10 | — | — | — | — | — | — | — | — |
| | A-3-1 | 100 | — | — | — | — | — | — | — |
| | A-3-2 | — | 100 | — | — | — | — | — | — |
| | A-3-3 | — | — | 100 | — | — | — | — | — |
| | A-3-4 | — | — | — | 100 | — | — | — | — |
| | A-3-5 | — | — | — | — | 100 | — | — | — |
| | A-3-6 | — | — | — | — | — | 100 | — | — |
| | A-3-7 | — | — | — | — | — | — | 100 | — |
| | A-3-8 | — | — | — | — | — | — | — | 100 |
| | A-3-9 | — | — | — | — | — | — | — | — |
| Photosensitive | B-1 | 5 | — | — | — | — | — | — | — |
| polysiloxane | B-2 | — | 10 | — | — | — | — | — | 2 |
| (B) | B-3 | — | — | 12 | — | — | — | — | 2 |
| | B-4 | — | — | — | 20 | — | — | 8 | — |
| | B-5 | — | — | — | — | 3 | — | — | — |
| | B-6 | — | — | — | — | — | 25 | — | — |
| Other | B′-1 | — | — | — | — | — | — | — | — |
| polysiloxanes | B′-2 | — | — | — | — | — | — | — | — |
| (B′) | B′-3 | — | — | — | — | — | — | — | — |
| Solvent (C) | C-1 | 1200 | — | 800 | 700 | — | 1000 | 900 | 850 |
| | C-2 | 600 | 1600 | — | 700 | 1200 | — | 900 | 850 |
| | C-3 | — | — | 1000 | — | 100 | — | 300 | — |
| Additive (D) | D-1 | — | — | 2 | — | — | — | — | — |
| | D-2 | — | — | — | — | — | — | 1 | — |
| Evaluation | Pre-tilt | X | X | X | X | X | X | X | X |
| Items | angle | | | | | | | | |
| | Light | | | | | | | | |
| | stability | | | | | | | | |
| Component | | Comparative example | | | | | | | |
| (unit: parts by weight) | | 9 | 10 | 11 | 12 | 13 | 14 | 15 | 16 |
| Polymer (A) | A-1-1 | — | 100 | — | 100 | — | — | — | — |
| | A-1-2 | — | — | — | — | — | — | — | — |
| | A-1-3 | — | — | — | — | — | — | — | — |
| | A-2-1 | — | — | 100 | — | 100 | — | — | — |
| | A-2-2 | — | — | — | — | — | 100 | — | — |
| | A-2-3 | — | — | — | — | — | — | — | — |
| | A-2-4 | — | — | — | — | — | — | — | — |
| | A-2-5 | — | — | — | — | — | — | — | — |
| | A-2-6 | — | — | — | — | — | — | — | — |
| | A-2-7 | — | — | — | — | — | — | — | — |
| | A-2-8 | — | — | — | — | — | — | — | — |
| | A-2-9 | — | — | — | — | — | — | — | — |
| | A-2-10 | — | — | — | — | — | — | — | — |
| | A-3-1 | — | — | — | — | — | — | 100 | — |
| | A-3-2 | — | — | — | — | — | — | — | — |
| | A-3-3 | — | — | — | — | — | — | — | — |
| | A-3-4 | — | — | — | — | — | — | — | — |
| | A-3-5 | — | — | — | — | — | — | — | — |
| | A-3-6 | — | — | — | — | — | — | — | 100 |
| | A-3-7 | — | — | — | — | — | — | — | — |
| | A-3-8 | — | — | — | — | — | — | — | — |
| | A-3-9 | 100 | — | — | — | — | — | — | — |
| Photosensitive | B-1 | — | — | — | — | — | — | — | — |
| polysiloxane | B-2 | — | — | — | — | — | — | — | — |
| (B) | B-3 | — | — | — | — | — | — | — | — |
| | B-4 | — | — | — | — | — | — | — | — |
| | B-5 | 6 | — | — | — | — | — | — | — |
| | B-6 | — | — | — | — | — | — | — | — |
| Other | B′-1 | — | — | — | 5 | — | — | 5 | — |
| polysiloxanes | B′-2 | — | — | — | — | 10 | — | — | 3 |
| (B′) | B′-3 | — | — | — | — | — | 12 | — | — |
| Solvent (C) | C-1 | 2000 | 1200 | 700 | 1200 | — | 800 | 1200 | — |
| | C-2 | — | 600 | 700 | 600 | 1600 | — | 600 | 1200 |
| | C-3 | — | — | — | — | — | 1000 | — | 100 |
| Additive (D) | D-1 | — | — | — | — | — | 2 | — | — |
| | D-2 | — | — | — | — | — | — | — | — |
| Evaluation | Pre-tilt | X | X | X | X | X | X | X | X |
| Items | angle | | | | | | | | |
| | Light | | | | | | | | |
| | stability | | | | | | | | |

### <Evaluation Results>

It can be known from Table 4 and Table 5 that, in comparison to the liquid crystal alignment films made from the liquid crystal alignment agent containing both the polymer (A) including the diamine compound (a2-1) and the photosensitive polysiloxane (B) (example 1 to example 15), the pre-tilt angle light stability of the liquid crystal alignment films formed by the polymer (A) without the diamine compound (a2-1) (comparative examples 1 to 9, 15, and 16) is poor; and the pre-tilt angle light stability of the liquid crystal alignment films formed by the liquid crystal alignment agent without the photosensitive polysiloxane (B) (comparative example 10 to comparative example 16) is poor.

Moreover, when the imidization ratio of the polymer (A) in the liquid crystal alignment agent is 3% to 50%, the pre-tilt angle light stability of the formed liquid crystal alignment films (examples 4 to 7, 11, 13, and 15) is better.

Moreover, when the molar equivalent ratio (b2)/(b1-1) of the cinnamic acid derivative (b2) and the silane compound (b1-1) containing an epoxy group of the photosensitive polysiloxane (B) in the liquid crystal alignment agent is 0.1 to 0.7, the pre-tilt angle light stability of the formed liquid crystal alignment films (examples 2, 3, 5, 8, 9, 11, and 14) is better.

Moreover, when the polymer (A) in the liquid crystal alignment agent contains the diamine compound (a2-2) represented by formula (II-1), formula (II-2), or formula (II-26) to formula (II-30), the pre-tilt angle light stability of the formed liquid crystal alignment films (examples 2, 5, 7, 10, and 12) is better.

Based on the above, since the polymer in the liquid crystal alignment agent of the invention is formed by a diamine compound containing a specific structure, and the liquid crystal alignment agent includes the photosensitive polysiloxane formed by the reaction of a polysiloxane containing an epoxy group and a cinnamic acid derivative, when the liquid crystal alignment agent is applied in a liquid crystal alignment film, the liquid crystal alignment film has better pre-tilt angle light stability, such that the liquid crystal alignment film is suitable for a liquid crystal display element.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A liquid crystal alignment agent, comprising:
a polymer (A);
a photosensitive polysiloxane (B); and
a solvent (C),
wherein the polymer (A) is obtained by reacting a mixture, and the mixture comprises a tetracarboxylic dianhydride component (a1) and a diamine component (a2),
the diamine component (a2) comprises a diamine compound (a2-1) represented by formula (1), 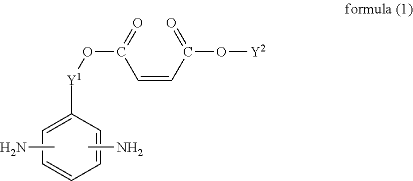
in formula (1),
Y¹ represents a C₁ to C₁₂ alkylene group;
Y² represents a group having a steroid skeleton or a group represented by formula (1-1), 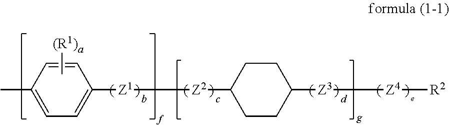
in formula (1-1),
R¹ each independently represents a fluorine atom or a methyl group;
R² represents a hydrogen atom, a fluorine atom, a C₁ to C₁₂ alkyl group, a C₁ to C₁₂ fluoroalkyl group, a C₁ to C₁₂ alkoxy group, —OCH₂F, —OCHF₂, or —OCF₃;
Z¹, Z², and Z³ each independently represent a single bond, a C₁ to C₃ alkylene group, 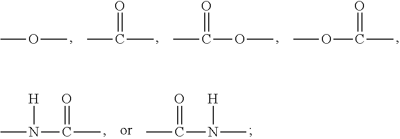
Z⁴ each independently represents 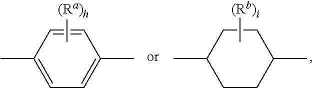
R^{a} and R^{b} each independently represent a fluorine atom or a methyl group, and h and i each independently represent 0, 1, or 2;
a represents 0, 1, or 2;
b, c, and d each independently represent an integer of 0 to 4;
e, f, and g each independently represent an integer of 0 to 3, and e+f+g≧1;
the photosensitive polysiloxane (B) is obtained by reacting a silane compound (b1-1) containing an epoxy group and a cinnamic acid derivative (b2).

2. The liquid crystal alignment agent of claim 1, wherein the silane compound (b1-1) containing an epoxy group comprises at least one of a group represented by formula (2-1), a group represented by formula (2-2), and a group represented by formula (2-3), 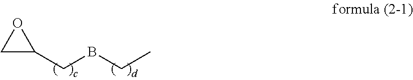
in formula (2-1), B represents an oxygen atom or a single bond; c represents an integer of 1 to 3; d represents an integer of 0 to 6, wherein when d represents 0, B is a single bond, 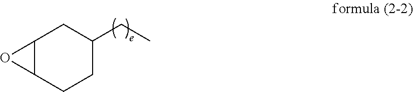
in formula (2-2), e represents an integer of 0 to 6, 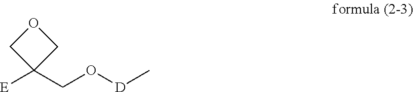
in formula (2-3), D represents a C₂ to C₆ alkylene group; E represents a hydrogen atom or a C₁ to C₆ alkyl group.

3. The liquid crystal alignment agent of claim 1, wherein the cinnamic acid derivative (b2) is at least one in the group consisting of compounds represented by formula (3-1) to formula (3-2), 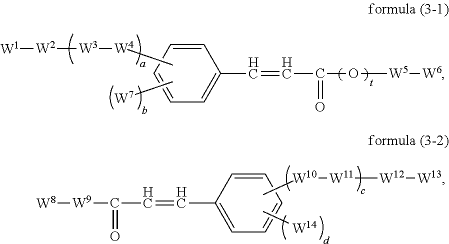
in formula (3-1),
W¹ represents a hydrogen atom, a C₁ to C₄₀ alkyl group, or a C₃ to C₄₀ monovalent organic group containing an alicyclic group, wherein a portion of or all of the hydrogen atoms of the alkyl group can be substituted by fluorine atoms;
W² represents a single bond, an oxygen atom, —COO—, or —OCO—;
W³ represents a divalent aromatic group, a divalent alicyclic group, a divalent heterocyclic group, or a divalent fused-ring group;
W⁴ represents a single bond, an oxygen atom, —COO—, or —OCO—;
W⁵ represents a single bond, a methylene group, a C₂ to C₁₀ alkylene group, or a divalent aromatic group;
when W⁵ represents a single bond, t represents 0, and W⁶ is a hydroxyl group or —SH;
when W⁵ represents a methylene group, an alkylene group, or a divalent aromatic group, t represents 0 or 1, and W⁶ is a carboxylic acid group, a hydroxyl group, —SH, —NCO, —NHW, —CH═CH₂, or —SO₂Cl, wherein W represents a hydrogen atom or a C₁ to C₆ alkyl group;
W⁷ represents a fluorine atom or a cyano group;
a represents an integer of 0 to 3;
b represents an integer of 0 to 4;
in formula (3-2),
W⁸ represents a C₁ to C₄₀ alkyl group or a C₃ to C₄₀ monovalent organic group containing an alicyclic group, wherein a portion of or all of the hydrogen atoms of the alkyl group can be substituted by fluorine atoms;
W⁹ represents a single bond, an oxygen atom, or a divalent aromatic group;
W¹⁰ represents an oxygen atom, —COO—, or —OCO—;
W¹¹ represents a divalent aromatic group, a divalent heterocyclic group, or a divalent fused-ring group;
W¹² represents a single bond, —OCO—(CH₂)ₑ—*, or —O—(CH₂)_{g}—*, wherein e and g each independently represent an integer of 1 to 10, and * each independently represent a bond with W¹³;
W¹³ represents a carboxylic acid group, a hydroxyl group, —SH, —NCO, —NHW, —CH═CH₂, or —SO₂Cl, wherein W represents a hydrogen atom or a C₁ to C₆ alkyl group;
W¹⁴ represents a fluorine atom or a cyano group;
c represents an integer of 0 to 3;
d represents an integer of 0 to 4.

4. The liquid crystal alignment agent of claim 1, wherein based on a usage amount of 100 moles of the diamine component (a2), a usage amount of the diamine compound (a2-1) is 0.5 moles to 20 moles.

5. The liquid crystal alignment agent of claim 1, wherein based on 100 parts by weight of the polymer (A), a usage amount of the photosensitive polysiloxane (B) is 3 parts by weight to 30 parts by weight; and a usage amount of the solvent (C) is 800 parts by weight to 4000 parts by weight.

6. The liquid crystal alignment agent of claim 1, wherein a molar equivalent ratio (b2)/(b1−1) of the cinnamic acid derivative (b2) to the silane compound (b1−1) containing an epoxy group is 0.1 to 0.7.

7. The liquid crystal alignment agent of claim 1, wherein an imidization ratio of the polymer (A) is 3% to 50%.

8. A liquid crystal alignment film formed by the liquid crystal alignment agent of claim 1.

9. A liquid crystal display element, comprising the liquid crystal alignment film of claim 8.
